(19) United States
(12) Patent Application Publication
(10) Pub. No.: US 2011/0284158 A1
(43) Pub. Date: Nov. 24, 2011

(54) Method and apparatus of manufacturing functionally gradient material

(75) Inventor: Manabu Katsumura, Kanagawa-ken (JP)

(73) Assignee: FUJIFILM Corporation, Tokyo (JP)

(21) Appl. No.: 13/067,223

(22) Filed: May 18, 2011

(30) Foreign Application Priority Data
May 20, 2010 (JP) 2010-116527
May 18, 2011 (JP) 2011-111602

(51) Int. Cl. B32B 38/14; B05C 5/02

(52) U.S. Cl. 156/277; 156/356

(57) ABSTRACT

A method of manufacturing a functionally gradient material having a gradient from a first material to a second material different to the first material by ejecting inks onto a base material from a plurality of inkjet heads, includes the steps of: supplying a first functional ink containing the first material to a first inkjet head; supplying a second functional ink containing the second material to a second inkjet head; specifying a ratio between a volume of the first functional ink ejected from the first inkjet head and a volume of the second functional ink ejected from the second inkjet head; causing the first inkjet head to eject the first functional ink and/or causing the second inkjet head to eject the second functional ink, in accordance with the specified ratio, so as to form one layer; and stacking a plurality of layers onto the base material by repeating the forming step, so as to obtain a laminated body, wherein in the control step, the ratio between the first functional ink and the second functional ink is specified in such a manner that respective layers of the plurality of layers progressively have a smaller ratio of the first functional ink and a larger ratio of the second functional ink, toward an upper layer.

### BACKGROUND OF THE INVENTION

1. Field of the Invention

The present invention relates to a method and an apparatus of manufacturing a functionally gradient material, and more particularly, to technology for manufacturing a functionally gradient material using inkjet technology.

2. Description of the Related Art

An inkjet recording apparatus is known which forms an image on a recording medium by ejecting ink droplets from nozzles so as to deposit the ejected droplets on a recording medium, such as paper, by means of actuators of piezo elements. In recent years, the nozzle arrangement pitch in inkjet recording apparatuses has increased in density and it has also become possible to eject very small ink droplets of several pl (pico-liter), which means that recording of high-resolution images has become possible.

Techniques for using an inkjet apparatus of this kind in applications other than image recording have been proposed.

For example, Japanese Patent Application Publication No. 2007-88221 discloses a method of manufacturing a ceramic electronic component forming a conductor, by printing a precious metal ink containing an inorganic binding material onto a ceramic substrate, further over-coating ink made of precious metal only onto the region where the precious metal ink has been printed, and then carrying out heat treatment.

The ink on the ceramic substrate acts as a chemical bonding component which generates chemical bonds with the ceramic substrate, as a result of the heat treatment, and also functions as a gradient material, by spreading in accordance with the precious metal ink.

According to this technology, it is possible to keep the inefficiency of the conductor low, while improving the bonding strength of the surface electrode with respect to the ceramic substrate.

Functionally gradient materials are known in which the properties, function, composition, or the like, gradually change continuously or in a stepwise fashion, within the same material.

However, Japanese Patent Application Publication No. 2007-88221 discloses a technique forming a conductor which is ensured to have adhering strength properties with respect to a substrate and has about the same low resistivity as a simple precious metal body by arranging an ink containing an inorganic bonding agent between the substrate and a precious metal ink. However, Japanese Patent Application Publication No. 2007-88221 fails to teach functional materials in which properties, or the like, gradually change continuously or in a stepwise fashion.

### SUMMARY OF THE INVENTION

The present invention has been contrived in view of these circumstances, an object thereof being to provide a method and an apparatus of manufacturing a functionally gradient material using inkjet technology.

In order to attain an object described above, one aspect of the present invention is directed to a method of manufacturing a functionally gradient material having a gradient from a first material to a second material different to the first material by ejecting inks onto a base material from a plurality of inkjet heads, the method comprising: a first supply step of supplying a first functional ink containing the first material to a first inkjet head; a second supply step of supplying a second functional ink containing the second material to a second inkjet head; a control step of specifying a ratio between a volume of the first functional ink ejected from the first inkjet head and a volume of the second functional ink ejected from the second inkjet head; a forming step of causing the first inkjet head to eject the first functional ink and/or causing the second inkjet head to eject the second functional ink, in accordance with the specified ratio, so as to form one layer; and a laminating step of stacking a plurality of layers onto the base material by repeating the forming step, so as to obtain a laminated body, wherein in the control step, the ratio between the first functional ink and the second functional ink is specified in such a manner that respective layers of the plurality of layers progressively have a smaller ratio of the first functional ink and a larger ratio of the second functional ink, toward an upper layer.

In order to attain an object described above, another aspect of the present invention is directed to a method of manufacturing a functionally gradient material having a gradient from a first material to a second material different to the first material by ejecting inks onto a base material from a plurality of inkjet heads, the method comprising: a supply step of supplying a plurality of inkjet heads respectively with a plurality of mixed inks in which a first functional ink containing the first material and a second functional ink containing the second material are mixed at respectively different mix ratios; a selection step of selecting one inkjet head in order from the plurality of inkjet heads according to a ration of the first functional ink, the inkjet head being selected in order from an inkjet head to which a mixed ink having a highest ratio of the first functional ink is supplied; a forming step of causing the selected inkjet head to eject the mixed ink so as to form one layer; and a laminating step of stacking a plurality of layers onto the base material by repeating the forming step, so as to obtain a laminated body.

In order to attain an object described above, another aspect of the present invention is directed to an apparatus for manufacturing a functionally gradient material having a gradient from a first material to a second material different to the first material by ejecting inks onto a base material from a plurality of inkjet heads, the apparatus comprising: a first inkjet head which ejects a first functional ink containing the first material; a second inkjet head which ejects a second functional ink containing the second material; a control device which controls a volume of the first functional ink ejected from the first inkjet head and a volume of the second functional ink ejected from the second inkjet head; a forming device which causing the first inkjet head and the second inkjet head to eject the first functional ink and the second functional ink so as to form one layer; and a laminating device which obtains a laminated body by stacking a plurality of layers by the forming device, wherein the control device specifies a ratio between the first functional ink and the second functional ink in such a manner that respective layers of the plurality of layers progressively have a smaller ratio of the first functional ink and a larger ratio of the second functional ink, toward an upper layer.

In order to attain an object described above, another aspect of the present invention is directed to an apparatus for manufacturing a functionally gradient material having a gradient from a first material to a second material different to the first material by ejecting inks on a base material from a plurality of inkjet heads, the apparatus comprising: a supply device which supplies the plurality of inkjet heads respectively with a plurality of mixed inks in which a first functional ink containing the first material and a second functional ink containing the second material are mixed at respectively different mix ratios; a selection device which selects one inkjet head in order from the plurality of inkjet heads according to a ration of the first functional ink, the inkjet head being selected in order from an inkjet head to which a mixed ink having a highest ratio of the first functional ink is supplied; a forming device which causes the selected inkjet head to eject the mixed ink so as to form one layer; and a laminating device which obtains a laminated body by stacking a plurality of layers on the base material by repeating formation of the layer by the forming device.

According to the present invention, the ratio between the volume of a first functional ink ejected from a first inkjet head and the volume of a second functional ink ejected from a second inkjet head is specified, a plurality of layers are superimposed onto a base material by repeating a step of forming one layer by ejecting inks in accordance with the specified ratio, and the respective layers of the plurality of layers progressively have a smaller ratio of the first functional ink and a larger ratio of the second functional ink, toward the upper layer; therefore, it is possible to manufacture a functionally gradient material using inkjet technology.

### BRIEF DESCRIPTION OF THE DRAWINGS

A preferred embodiment of this invention as well as other objects and benefits thereof, will be explained in the following with reference to the accompanying drawings, in which like reference characters designate the same or similar parts throughout the figures and wherein:

FIG. 1 is a diagram of a bump having a functional gradient;

FIG. 2 is a general schematic drawing of a bump forming apparatus;

FIG. 3 is a schematic drawing of an image formation unit of a bump forming apparatus;

FIGS. 4A to 4E are diagrams for describing bump formation by an image formation mixing method;

FIG. 5 is a schematic cross-sectional diagram showing a state after mounting of an IC chip on which a bump has been formed;

FIGS. 6A to 6C are step diagrams for describing a further embodiment of an image formation mixing method;

FIG. 7 is a general schematic drawing of a bump forming apparatus relating to a second embodiment;

FIGS. 8A to 8C are diagrams for describing bump formation by a mixed ink method;

FIGS. 9A and 9B are diagrams showing lyophobic processing sections formed on edge portions;

FIGS. 10A to 10C are diagrams showing an edge frame formed on edge portions;

FIGS. 11A and 11B are schematic drawings showing a relationship between a base material and a head;

FIG. 12 is a diagram showing image formation traces generated in an ink layer;

FIGS. 13A to 13C are diagrams for describing countermeasures for image formation traces;

FIGS. 14A to 14D are diagrams for describing depositing positions of respective functional inks in an image formation mixing method;

FIGS. 15A to 15C are schematic diagrams illustrating disposition of a chemical solution for retaining a semi-dried state;

FIGS. 16A to 16C are schematic diagrams illustrating a chemical solution treatment in which a chemical solution is disposed before forming a mixed layer;

FIGS. 17A to 17C are schematic diagrams illustrating a chemical solution treatment in which a chemical solution is disposed after forming a mixed layer;

FIGS. 18A to 18C are schematic diagrams illustrating a chemical solution treatment in which a chemical solution is disposed during formation of a mixed layer;

FIGS. 19A to 19E are schematic diagrams illustrating formation of a bump using four types of components in an image formation mixing method; and

FIGS. 20A and 20B are diagrams illustrating landing positions of each functional ink according to further embodiments of the invention.

### DETAILED DESCRIPTION OF THE PREFERRED EMBODIMENTS

Here, a bump forming apparatus is described which forms bumps on pads (electrodes) of an IC chip formed on an IC wafer. A bump is a hemispherical or trapezoid metal protuberance formed on an electrical terminal section and is used when mounting an IC chip directly on a printed wiring board.

Normally, gold (Au) is used as the top surface of a bump, since it is stable and pliable metal, and not liable to oxidation. However, it has a drawback due to its high price.

On the other hand, for the film forming an electrode of an IC chip, it is suitable to use copper (Cu) film which is inexpensive, has high conductivity, and is used commonly at present as a mounting wire material. Moreover, there is also a benefit in using Cu film in that the migration resistance is better than when using Au. However, Cu is disadvantageous in that it oxidizes readily and is not necessarily suitable for the top surface of a bump.

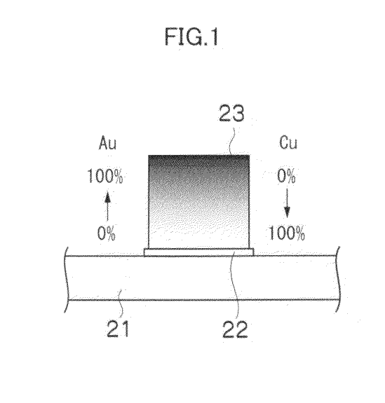

Consequently, as shown in FIG. 1, a bump 23 formed on an electrode 22 of an IC chip 21 is desirably formed so as to have a gradient from Cu to Au, from the electrode 22 side to the top surface. In the present embodiment, a bump having a compositional ratio which varies from 100% Cu to 100% Au is formed by an image formation mixing method. An image formation mixing method is a method in which a plurality of types (here, two types) of pure ink (100% functional ink) are mixed together by an image formation method. Bumps have various thicknesses, but here the bump thickness is taken to be approximately 10 μm.

### First Embodiment

### Configuration of Bump Forming Apparatus

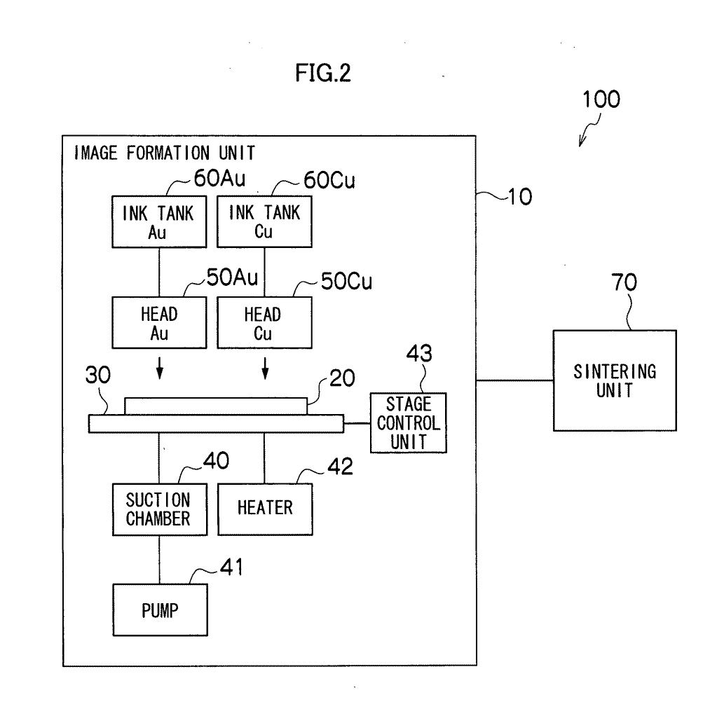

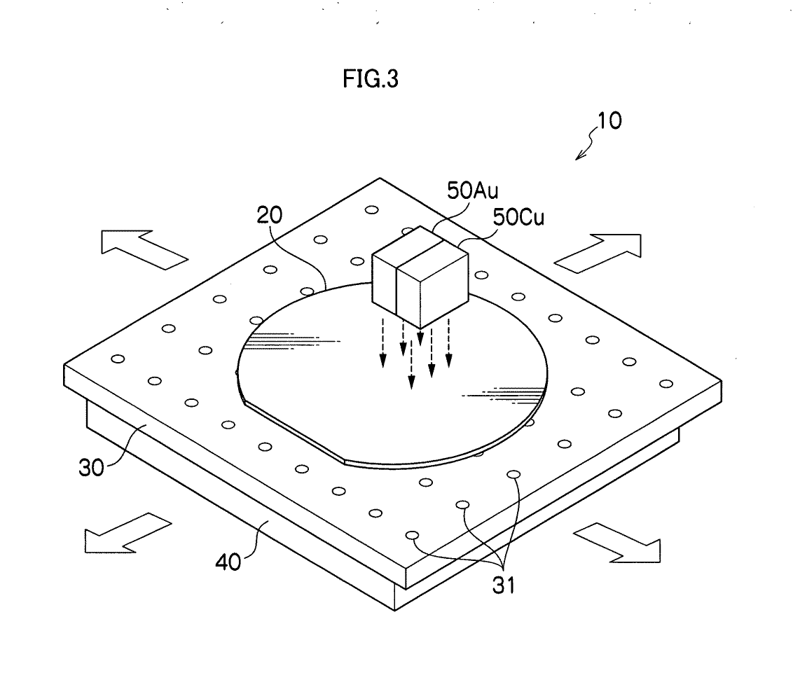

FIG. 2 is a general schematic diagram of a bump forming apparatus 100 relating to a first embodiment, and FIG. 3 is a schematic drawing of an image formation unit 10 of the bump forming apparatus 100. As shown in FIGS. 2 and 3, the bump forming apparatus 100 has an image formation unit 10 and a sintering unit 70, and the image formation unit 10 employs a flat head type inkjet image forming apparatus. More specifically, the image formation unit 10 includes a stage 30 on which an IC wafer 20 forming a base material is loaded, a suction chamber 40 for holding the IC wafer 20 loaded on the stage 30, by suction, and inkjet head 50Au and inkjet head 50Cu which eject respective inks onto the IC wafer 20.

The IC wafer 20 is a plate-shaped member that is made of silicon and has a substantially circular planar shape, and a plurality of IC chips 21 (not illustrated in FIG. 2 and FIG. 3) are formed on the surface of the IC wafer 20.

The stage 30 has a width dimension which is greater than the diameter of the IC wafer 20, and is composed so as to be movable freely in the horizontal direction by means of a movement mechanism (not illustrated). For the movement mechanism, it is possible to use a rack-and-pinion mechanism or a ball screw mechanism, for example. A stage control unit 43 (not illustrated in FIG. 3) is able to move the stage 30 to a desired position by controlling the movement mechanism.

The inkjet head 50Au and the inkjet head 50Cu may be composed freely movably in the horizontal direction and the inkjet head 50Au and the inkjet head 50Cu may be moved with respect to a fixed IC wafer 20, or both “the inkjet head 50Au and the inkjet head 50Cu” and “the IC wafer 20” may be moved.

Furthermore, as shown in FIG. 3, a lot of suction holes 31 are formed in a wafer holding surface of the stage 30. A suction chamber 40 is provided on the lower surface of the stage 30, and an IC wafer 20 on the stage 30 is held by suction due to the vacuum chamber 40 being vacuum suctioned by a pump 41 (not shown in FIG. 3 and see FIG. 2). Furthermore, the stage 30 comprises a heater 42 (not shown in FIG. 3 and see FIG. 2), and the IC wafer 20 held by suction on the stage 30 can be heated by the heater 42.

The inkjet head 50Au and inkjet head 50Cu eject inks supplied from ink tank 60Au and ink tank 60Cu (not shown in FIG. 3 and see FIG. 2), at desired positions on the IC wafer 20, and here heads having piezo actuators are employed. The inkjet heads 50Au and 50Cu are respectively arranged and fixed as closely as possible to each other, by means of a fixing device which is not illustrated.

The inks supplied from the ink tanks 60Au and 60Cu to the inkjet head 50Au and inkjet head 50Cu are respectively Au nano-particle ink and Cu nano-particle ink. These inks are formed by dispersing respective metal nano-particles in a prescribed organic solvent. Since the Cu nano-particle ink is liable to oxidize, the bump forming apparatus 100 is composed in such a manner that bump formation can be carried out in an inert gas atmosphere, such as nitrogen, in order to prevent oxidation of the Cu nano-particle ink. The sintering unit 70 is an oven equipped with a heater and is capable of sintering a bump formed on an IC wafer 20 by the image formation unit 10, by heating the IC wafer 20.

### Bump Formation

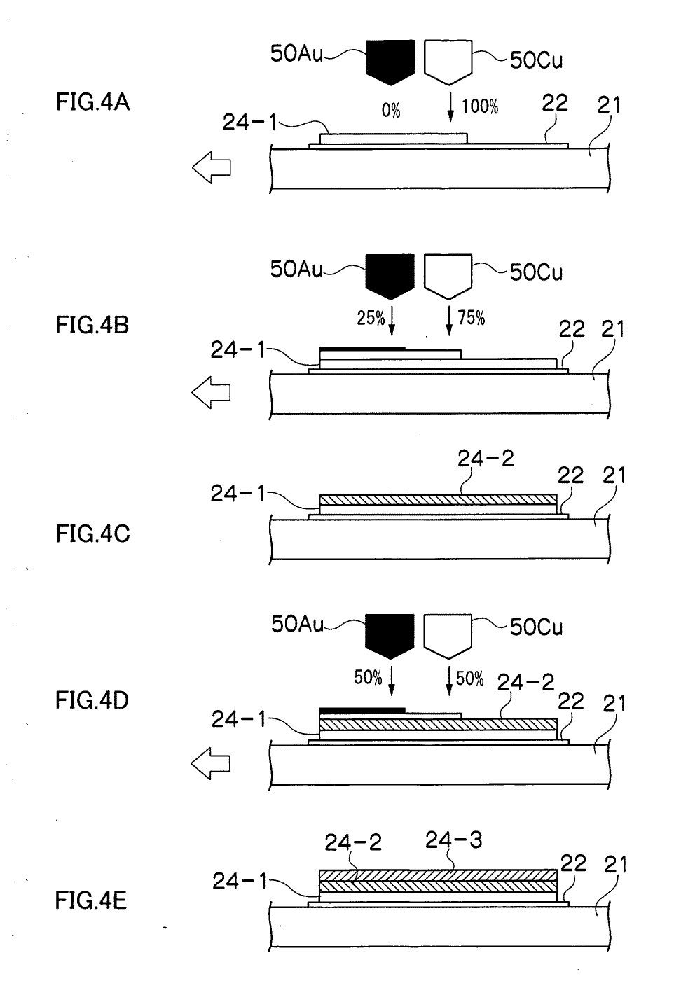

The formation of a bump using the bump forming apparatus 100 composed in this way will now be described with reference to FIGS. 4A to 4E.

Firstly, an IC wafer 20 is loaded on the stage 30 of the image formation unit 10 (see FIG. 3) which is situated in a nitrogen atmosphere. The IC wafer 20 is loaded in such a manner that the rear surface (the surface where the IC chip 21 is not formed) is in contact with the stage 30. The IC wafer 20 is suctioned onto the stage 30 and heated, by means of the suction chamber 40. Here, the wafer 20 is heated to 70° C.

Next, a Cu nano-particle ink layer 24-1 is formed by laminating one layer or a plurality of layers of Cu nano-particle ink directly on top of an electrode 22 on the IC chip 21 which is formed on the suctioned and heated IC wafer 20. As shown in FIG. 4A, the Cu nano-particle ink is laminated by ejecting Cu nano-particle ink onto the electrode 22 from an inkjet head 50Cu while moving the stage 30 by means of a movement mechanism (moving it in the leftward direction in FIG. 4A). Here, ink is not ejected from the inkjet head 50Au.

Since the electrode 22 is a metal film formed by sputtering, or the like, then it may be impossible to form an accurate layer, for instance, the Cu nano-particle ink ejected by the inkjet head 50Cu may wet and spread to a very large extent, making it impossible to form a desired pattern, or the film thickness in the center of the film may become too thin due to a “coffee stain effect”.

A phenomenon of this kind can be reduced by heating the IC wafer 20 as in the present embodiment, but it is also possible to form one layer by ejecting in a split fashion (intermittent ejection) in such a manner that, rather than ejecting ink onto the whole surface in one movement of the stage 30, the interval between dots deposited in one movement of the stage 30 is made larger than the prescribed dot pitch (the pitch of the lattice of ejected droplets), and the gaps between the dots that have been formed already are covered over by a plurality of movements of the stage.

The Cu nano-particle ink layer 24-1 formed in this way is dried (semi-dried, semi-cured) in such a manner that the solvent component in the Cu nano-particle ink is not completely evaporated off. More specifically, drying is performed with less energy than the energy applied when drying is performed in such a manner that the solvent component in the Cu nano-particle ink is completely evaporated off (full drying, full curing). A semi-cured state is a state where Cu nano-particles are laminated with a gap therebetween.

By setting the Cu nano-particle ink layer 24-1 to a semi-dried state, diffusion of the particles occurs at the interface with the mixed layer 24-2 (see FIG. 4B) which is laminated on the Cu nano-particle ink layer 24-1 and the adhesion between layers is made stronger.

Next, a mixed layer 24-2 of Cu nano-particle ink and Au nano-particle ink is formed on top of the Cu nano-particle ink layer 24-1 which is in a semi-dried state. As shown in FIG. 4B, this mixed layer 24-2 is formed by ejecting Cu nano-particle ink from the inkjet head 50Cu and simultaneously ejecting Au nano-particle ink from the inkjet head 50Au, while moving the stage 30.

In this case, the ejection volume of the Cu nano-particle ink and the ejection volume of the Au nano-particle ink are adjusted to a desired ratio. Here, the ejection volumes of the respective nozzles of the inkjet heads 50Cu and 50Au are adjusted in such a manner that the ejection volume of the Cu nano-particle ink is 75% and the ejection volume of the Au nano-particle ink is 25%.

The ratio between the volumes of the Cu nano-particle ink and the Au nano-particle ink may be adjusted in accordance with the dot pitch (dot density) of image formation. For example, it is also possible to adjust the ratio, by controlling ejections of the inkjet heads 50Cu and 50Au in such a manner that the ratio of the number of nozzles ejecting the Cu nano-particle ink to the number of nozzles ejecting the Au nano-particle ink becomes 75:25 while the ejection volume from each nozzle of the inkjet heads 50Cu and 50Au is kept uniform.

As shown in FIG. 4C, a mixed layer 24-2 is laminated by diffusing and mixing the Cu nano-particle ink and the Au nano-particle ink ejected at their own ejection volumes after the Cu nano-particle ink and the Au nano-particle ink are ejected.

Since the Cu nano-particle ink layer 24-1 is in a semi-dried state, then the solvent of the nano-particle ink of the mixed layer 24-2 formed thereon is received in the Cu nano-particle ink layer 24-1 and does not wet and spread to a very great extent.

In other words, the heating temperature created by the heater 42 needs to be adjusted in accordance with the evaporability of the ink (solvent component). Depending on the type of solvent, it is possible to form an image by setting the substrate temperature to a temperature lower than the 70° C. described above, for example, approximately 50° C.

Furthermore, the two inkjet heads 50Cu and 50Au are arranged as closely together as possible and hence it is possible to prevent only one of the Cu nano-particle ink or the Au nano-particle ink from drying and causing insufficient diffusion and mixing of the Cu nano-particle ink and the Au nano-particle ink in the mixed ink layer.

When the Cu nano-particle ink and the Au nano-particle ink are ejected simultaneously, it is possible to cause a droplet of Cu nano-particle ink ejected from the inkjet head 50Cu and a droplet of Au nano-particle ink ejected from the inkjet head 50Au to collide with each other in the air during flight and land after having combined with each other.

Moreover, as described in detail hereinafter, the two inkjet heads 50 Cu and 50 Au are desirably composed so as to each have a greater width where nozzles are provided than the width of one bump pattern (width of electrode), and one layer is formed by one movement of the stage 30. By this means, the Au nano-particle ink and the Cu nano-particle ink mix together more readily.

Furthermore, in order to promote diffusion and mixing of the inks, it is also possible to perform ultrasonic processing of the IC wafer 20 forming the base material, by controlling the stage 30. In this case, desirably, this processing is performed by carrying out sweeping of the frequency of the ultrasonic waves and changing the position of the IC wafer 20, so as to make nodes less liable to occur as a result of the ultrasonic waves.

If the mixed layer 24-2 formed in this way is in a semi-dried state similarly to the Cu nano-particle ink layer 24-1, then the mixed layer 24-2 is in a state where Au nano-particles and Cu nano-particles in a weight ratio of 25:75 are layered together with gaps therebetween.

Next, a mixed layer 24-3 is formed on top of the mixed layer 24-2. As shown in FIG. 4D, the mixed layer 24-3 is formed by ejecting the inks simultaneously from the inkjet head 50Cu and the inkjet head 50Au while moving the stage 30. Here, the Cu nano-particle ink and the Au nano-particle ink are both ejected at a ratio of 50%.

Since the mixed layer 24-2 is also in a semi-dried state, then the solvent in the nano-particle ink of the mixed layer 24-3 formed thereon is received in the mixed layer 24-2. As shown in FIG. 4E, after ink ejection, a mixed layer 24-3 is laminated by diffusing and mixing the two inks.

Moreover, the mixed layer 24-3 is also semi-dried. The mixed layer 24-3 is in a state where Au nano-particles and Cu nano-particles in a weight ratio of 50:50 are layered together with gaps therebetween.

In this way, respective mixed layers are formed while changing the ratio of the ejection volumes of the Cu nano-particle ink and the Au nano-particle ink in a stepwise fashion (so as to create a gradient), and finally a layer of 100% Au nano-particle ink is formed.

When formation of all of the layers has been completed, sintering is carried out at approximately 220° C. in a nitrogen atmosphere in the sintering unit 70. Consequently, the nano particles in each layer crystallize, diffusion of each layer progresses and the layers which have been formed in steps become continuous. As a result of this, as shown in FIG. 1, a bump 23 having a compositional ratio which changes from 100% Cu to 100% Au is formed.

By forming an upper layer while a lower layer is in a semi-dried state in this way, the diffusion can progress to a certain extent in the upper and lower layers. In this case, the state is avoided in which there is no interface between the upper and lower layers, in other words, the layers attain a state where they are completely mixed and there is no distinction between the upper and lower layers.

When the formation of each layer has been completed, a dummy pattern may be layered onto the area which does not function as the IC chip 21 of the IC wafer 20, and the height of the dummy pattern may be measured by a laser-based optical displacement sensor, or the like. The film thickness is higher in a state where drying has not progressed and solvent is remaining, and therefore it is possible to determine the state of drying from the height of the dummy pattern.

An IC wafer 20 on which a bump 23 has been formed in this way is diced into IC chips 21 by a dicing process, and the diced IC chip 21 is then mounted on a mounting substrate, or the like, by a so-called flip chip mount.

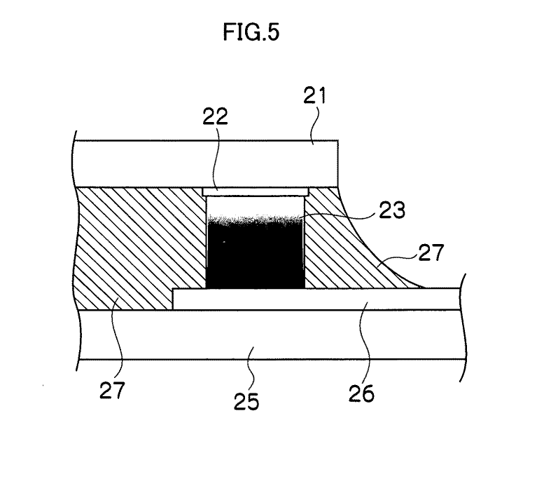

FIG. 5 is a schematic cross-sectional diagram showing a state after mounting of an IC chip 21 on which a bump 23 has been formed. The electrode 22 of the IC chip 21 and an electrode 26 of a printed substrate 25 are electrically connected via the bump 23, and are sealed with a molding resin 27.

Since the bottom surface of the bump 23 (the surface on the electrode 22 side) is made of Cu, then it is connected with the electrode 22 of the IC chip 21 in a state where it has increased resistance to migration phenomena. Furthermore, since the top surface of the bump 23 (the surface opposite to the electrode 22) is made of Au, then it is easy to perform mounting and the bump can be connected suitably with low resistance to the electrode 26 of the printed substrate 25.

As described above, it is possible to form a bump which is made of a functionally gradient material using an inkjet head. Furthermore, according to the image formation mixing method of the present embodiment, there is a merit in that regardless of the number of layers formed, few types of functional ink and a small number of inkjet heads only are required. Any number of mixed layers of the Au nano-particle ink and the Cu nano-particle ink may be laminated, provided that the layers are formed in such a manner that the mix ratio of the respective inks has a stepwise gradient.

Moreover, in the present embodiment, each layer is formed by ejecting the Cu nano-particle ink and the Au nano-particle ink simultaneously from the inkjet head 50Cu and the inkjet head 50Au, but the Cu nano-particle ink and the Au nano-particle ink may be ejected sequentially.

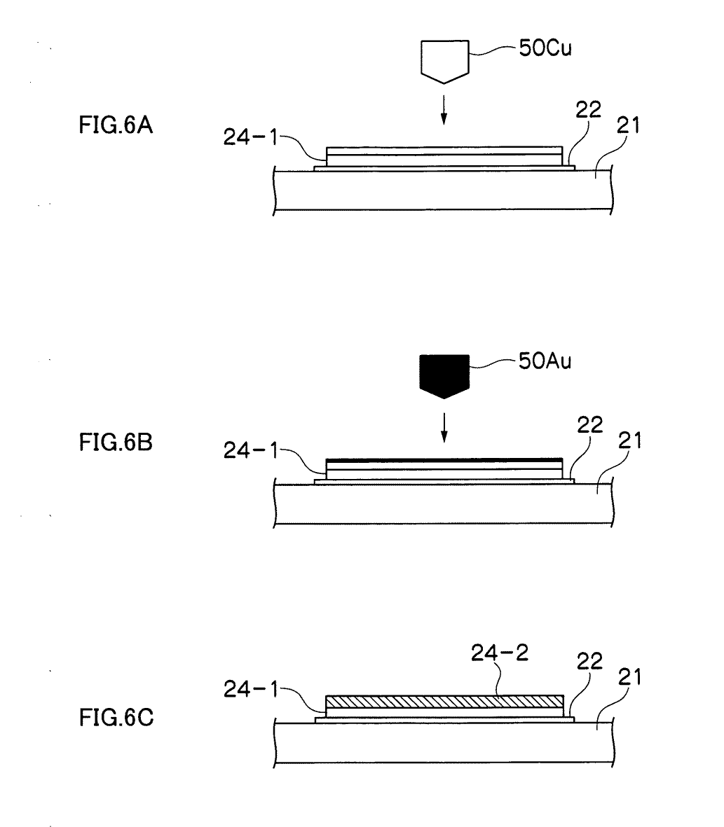

For example, when forming the mixed layer 24-2, as shown in FIG. 6A, firstly Cu nano-particle ink is ejected onto the whole surface of the Cu nano-particle ink layer 24-1 by the inkjet head 50Cu.

Thereupon, as shown in FIG. 6B, Au nano-particle ink is ejected onto the whole surface by the inkjet head 50Au. Subsequently, as shown in FIG. 6C, it is possible to form the mixed layer 24-2 similarly, by diffusing and mixing the respective inks.

When forming one layer by ejecting respective inks successively in this way, it is possible to adopt a composition whereby, if there is a difference between the ejection volumes of the two inks, in other words, if the ratio between the ejection volumes of the two inks is not 50%:50%, then the ink having the greater ejection volume is ejected first.

Especially if there is severe drying of the ink ejected first (in a case where the ink ejected first dries faster than the ink ejected subsequently), or the like, drying occurs more rapidly, the smaller the ejection volume of ink; therefore, it is desirable to eject the ink of greater ejection volume first. By this means, the diffusion and mixing of the inks of two types can be made to advance smoothly.

Moreover, in this case, the ink having the smaller ejection volume which is ejected subsequently may be ejected at a higher dot pitch density by means of droplets which are smaller than a prescribed size. By this means, the time taken for diffusion and mixing can be shortened.

Furthermore, it is also possible to deposit the ink ejected subsequently in a superimposed fashion, on the positions where the ink ejected first has been deposited. If intermittent ejection is performed and the dots are separated from each other, then if a droplet is deposited before a droplet ejected at the same position as the ink ejected first has dried, the respective inks are liable to diffuse and mix together.

Also possible is a mode where the inks (dots) to be mixed are caused to land simultaneously, by employing both intermittent ejection and simultaneous droplet ejection by two heads. Furthermore, in order to prevent landing interference between dots, a desirable mode is one where dots covering over the gaps between discretely arranged dots (dots of inks of two types which have diffused sufficiently) are formed while the discretely arranged dots are being dried.

One specific example of drying discretely arranged dots is a mode where the subsequently applied ink has been heated. By arranging the two heads in sufficiently close proximity to each other, it is possible to obtain an even greater effect.

For example, it is supposed that, in forming a mixed layer 24-2, Cu nano-particle ink has been ejected by intermittent ejection by the inkjet head 50Cu in a first scanning action.

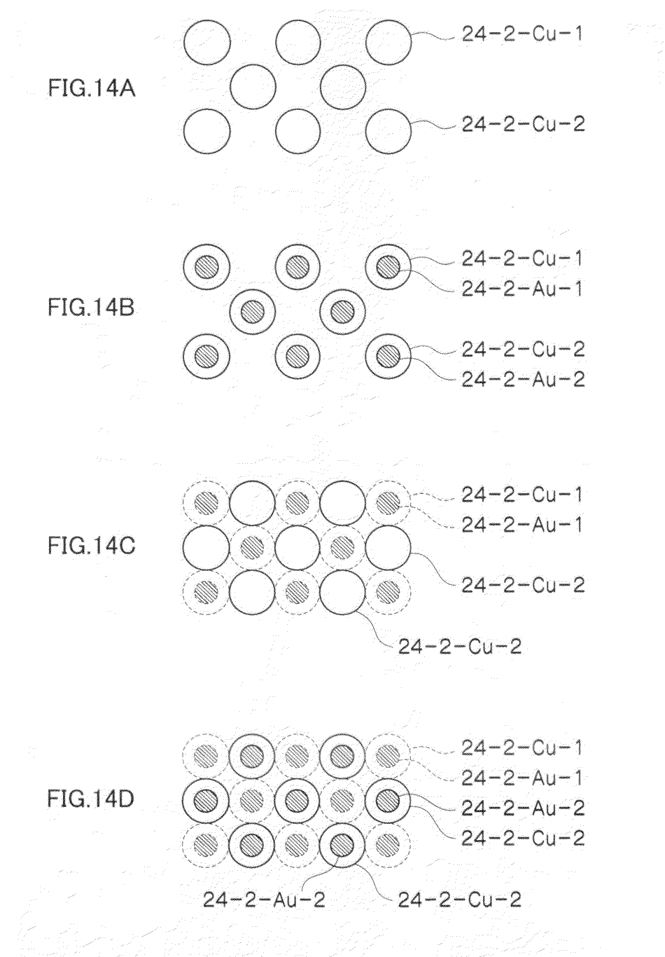

FIG. 14A shows Cu nano-particle ink 24-2-Cu-1 which has been deposited on top of the Cu nano-particle ink layer 24-1.

Next, in a second scanning action, Au nano-particle ink is ejected by intermittent ejection by the inkjet head 50Au. In this step, as shown in FIG. 14B, the inkjet head 50Au performs ejection in such a manner that the ejected Au nano-particle ink 24-2-Au-1 is deposited in a superimposed fashion at the same position as the Cu nano-particle ink 24-2-Cu-1 deposited in the first scanning action.

Moreover, Cu nano-particle ink is ejected intermittently by the inkjet head 50Cu in a third scanning action. FIG. 14C shows Cu nano-particle ink 24-2-Cu-2 which has been deposited between the dots of Cu nano-particle ink 24-2-Cu-1.

Thereupon, in a fourth scanning action, the inkjet head 50Au performs ejection in such a manner that Au nano-particle ink is deposited in superimposed fashion at the same positions as the Cu nano-particle ink 24-2-Cu-2. As shown in FIG. 14D, the inkjet head 50Au performs ejection in such a manner that the ejected Au nano-particle ink 24-2-Au-2 is deposited in a superimposed fashion at the same positions as the Cu nano-particle ink 24-2-Cu-2 deposited in the second scanning action.

Thereafter, in a similar fashion, inks are ejected onto the whole surface of the Cu nano-particle ink layer 24-1 and then diffused and mixed. By ejecting the Cu nano-particle ink and the Au nano-particle ink in this way, it is possible to shorten the time taken for diffusion and mixing when forming the mixed layer 24-2.

Moreover, if one of the two types of inks dries more quickly, then it is possible to eject the one of the inks subsequently (afterwards).

It is also possible to apply one of the two types of inks by a method other than an inkjet method, and to eject only the other ink of the two types of inks by an inkjet method. For example, when forming a gradient in a range having large differences between the volume ratios, for instance, where the ink mix ratios in the respective mixed layers are 99:1, 98:2, 97:3, 96:4 and 95:5, then it is possible to form a functionally gradient material efficiently by using an inkjet method to eject the functional ink having a smaller ratio.

As an application method other than the inkjet method, it is possible to employ a doctor blade, slit coating, spin coating, spray coating, screen printing, or the like.

Moreover, in the present embodiment, the respective mixed layers are formed using two pure inks, namely, Au nano-particle ink and Cu nano-particle ink, but it is also possible to make simultaneous use of inks in which these are diffused and mixed. For example, a mixed layer can be formed by simultaneously using inks of three types: two pure inks and a mixed ink having a 50:50 mix ratio of Au nano-particle ink and Cu nano-particle ink.

Although the number of inkjet heads increases in accordance with the mixed ink, since the two pure inks are sufficiently diffused and mixed together in advance in the mixed ink, then the time taken for diffusion and mixing after ejection of the ink can be shortened.

### Second Embodiment

Next, a second embodiment of the present invention will be described. The description given below does not explain the composition which is the same as or similar to that of the first embodiment described above. In the first embodiment, each layer of a bump which is a functionally gradient material are formed by an image formation mixing method which ejects a plurality of pure inks and diffuses and mixes the inks together by image formation, but in the second embodiment, each layer is formed by ejecting mixed inks which are diffused and mixed in advance.

### Composition of Bump Forming Apparatus

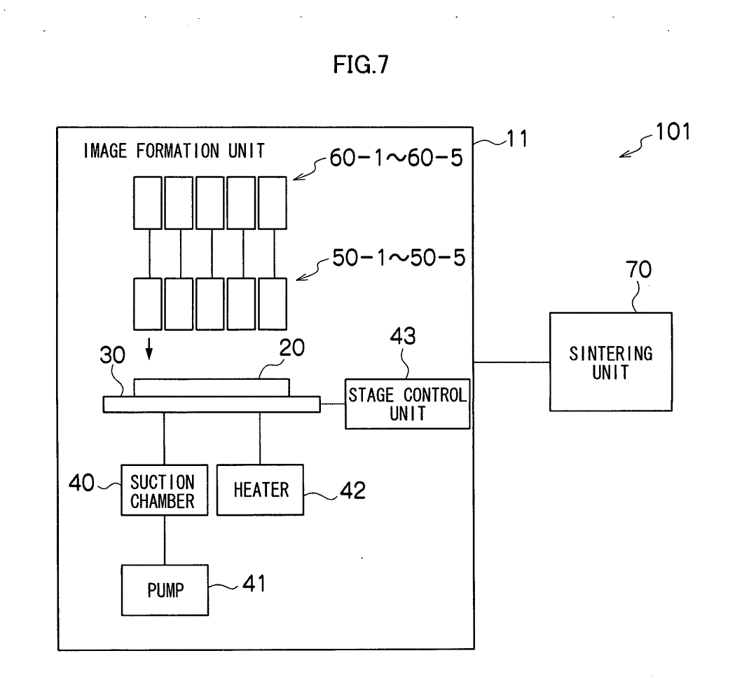

FIG. 7 is a general schematic drawing of a bump forming apparatus 101 relating to a second embodiment. As shown in FIG. 7, the bump forming apparatus 101 relating to the present embodiment includes an image formation unit 11, and the image formation unit 11 includes ink tanks 60-1 to 60-5 which store inks of five types, and inkjet heads 50-1 to 50-5 to which inks are supplied from the respective ink tanks 60-1 to 60-5. The inkjet heads 50-1 to 50-5 eject inks supplied from the respective ink tanks 60-1 to 60-5, onto an IC wafer 20.

The inks supplied from the ink tanks 60-1 to 60-5 to the inkjet heads 50-1 to 50-5 have respective mix ratios of Au nano-particle ink and Cu nano-particle ink of: 0:100, 25:75, 50:50, 75:25, 100:0. In other words, pure Cu nano-particle ink is supplied from the ink tank 60-1, pure Au nano-particle ink is supplied from the ink tank 60-5, and mixed inks in which Au nano-particle ink and Cu nano-particle ink are diffused and mixed at prescribed ratios are supplied from the ink tanks 60-2 to 60-4.

### Bump Formation

Similarly to the first embodiment, an IC wafer 20 is placed on the stage 30 and suctioning and heating are carried out (see FIG. 3).

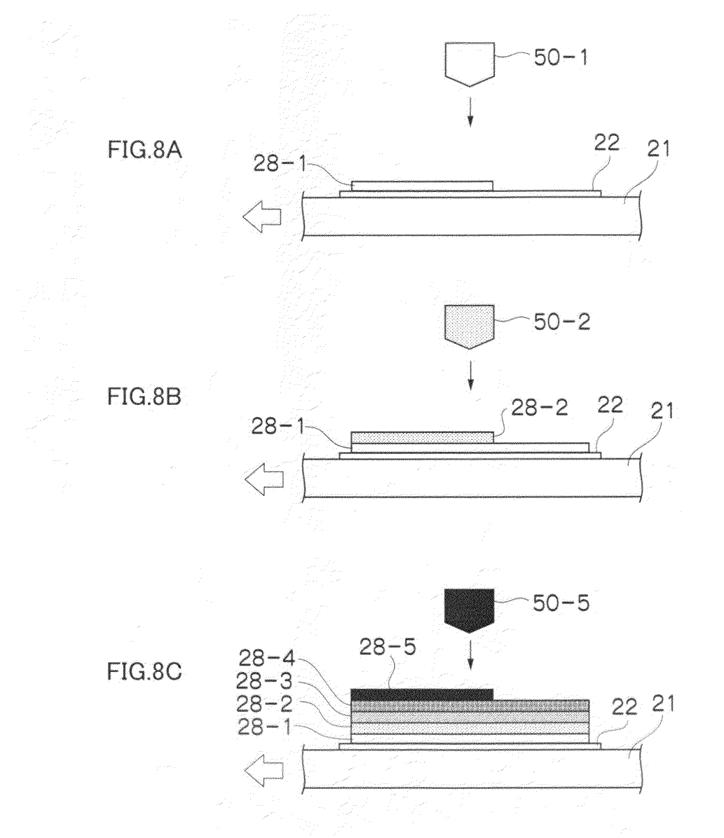

Next, a Cu nano-particle ink layer 28-1 is formed by laminating one layer or a plurality of layers of Cu nano-particle ink directly on top of an electrode 22 on an IC chip 21 which is formed on the suctioned and heated IC wafer 20. As shown in FIG. 8A, the Cu nano-particle ink is laminated by ejecting ink supplied from the ink tank 60-1 (pure Cu nano-particle ink having an Au nano-particle ink to Cu nano-particle ink mix ratio of 0:100) onto the electrode 22 by the inkjet head 50-1 while moving the stage 30 by means of the movement mechanism (moving it in the leftward direction in FIG. 8A). In this step, ink is not ejected from the other inkjet heads 50-2 to 50-5.

Consequently, the Cu nano-particle ink layer 28-1 formed in this way is a layer similar to the Cu nano-particle ink layer 24-1 shown in FIGS. 4A to 4E. Here, if the ink is dried to such an extent that the solvent in the Cu nano-particle ink is evaporated (semi-dried/semi-cured), then the Cu nano-particles are layered together with gaps therebetween.

Thereupon, a mixed layer 28-2 is formed on top of the Cu nano-particle ink layer 28-1 by ejecting a mixed ink (a mixed ink having an Au nano-particle ink to Cu nano-particle ink mix ratio of 25:75) supplied from the ink tank 60-2, by the inkjet head 50-2.

In forming the mixed layer 28-2, as shown in FIG. 8B, the mixed ink is ejected from the inkjet head 50-2 while moving the stage 30. Similarly to the first embodiment, since the Cu nano-particle ink layer 28-1 is in a semi-dried state, then the solvent of the nano-particle ink of the mixed layer 28-2 formed thereon is received in the Cu nano-particle ink layer 28-1 and does not wet and spread to a very great extent. Consequently, the heating temperature needs to be adjusted in accordance with the evaporability of the ink.

By semi-drying the mixed layer 28-2, the mixed layer 28-2 assumes a state where Au nano-particles and Cu nano-particles are layered together with gaps therebetween.

Moreover, a mixed layer 28-3 is formed on top of the mixed layer 28-2 by ejecting a mixed ink (a mixed ink having an Au nano-particle ink to Cu nano-particle ink mix ratio of 50:50) supplied from the ink tank 60-3, by the inkjet head 50-3.

Since the mixed layer 28-2 is in a semi-dried state, then the solvent in the nano-particle ink of the mixed layer 28-3 formed thereon is received in the mixed layer 28-2. Moreover, the mixed layer 28-3 is also semi-dried.

In this way, respective mixed layers are laminated by ejecting the respective mixed inks in order from the largest mix ratio of Cu nano-particle ink (i.e. in order from the smallest mix ratio of Au nano-particle ink) according to the mix ratio of Cu nano-particle ink, and lastly, a 100% Au nano-particle ink layer (Au nano-particle ink layer 28-5) is formed by ejecting Au nano-particle ink (pure Au nano-particle ink having an Au nano-particle ink to Cu nano-particle ink mix ratio of 100:0) supplied from the ink tank 60-5 by the inkjet head 50-5 (FIG. 8C).

When formation of all of the layers 28-1 to 28-5 has been completed, the nano-particles in each layer are crystallized by sintering at approximately 220° C. in a nitrogen atmosphere in the sintering unit 70. As a result of this, as shown in FIG. 1, a bump 23 having a compositional ratio which changes from 100% Cu to 100% Au is formed. The IC chip 21 can be mounted on the printed substrate 25 using this bump 23 as shown in FIG. 5.

As described above, it is possible to form a functionally gradient material using mixed inks. According to the ink mixing method of the present embodiment, since sufficient diffusing and mixing is achieved at the ink stage, then it is possible to create a functionally gradient material having highly accurate change of functional gradient. Furthermore, compared to the image formation mixing method of the first embodiment, time is not required for diffusing and mixing functional inks of two types, and therefore a benefit is gained in that the only a short process time is needed.

Furthermore, it is also possible to adopt a composition in which, when forming respective mixed layers, the base material and the inkjet heads 50-1 to 50-5 are moved relatively a plurality of times, dots are arranged discretely by performing intermittent droplet ejection in one relative movement, and the gaps between the discretely arranged dots are covered over by subsequent relative movements.

In this mode, landing interference between dots (ink) constituting respective layers is prevented and deformation of the shape of the respective layers is prevented. In this way, the occurrence of coffee stains (coffee rings) caused by deformation of each layer is prevented.

In the present embodiment, three mixed layers of Au nano-particle ink and Cu nano-particle ink are formed, but the number of layers is not limited in particular to this and any number of layers may be formed, provided that the layers are laminated so as to achieve a gradient of the mix ratio of the respective inks. It is necessary to prepare ink tanks and inkjet heads corresponding to the number of layers to be formed (i.e. the number of ink tanks and inkjet heads corresponds to the number of layers).

### Other Modification Examples

As described above, the formation of a bump is described as an example in one embodiment of the present invention, but a method and an apparatus for manufacturing a functionally gradient material relating to embodiments of the present invention have various modification examples.

Functionally Gradient Material which can be Produced

In a bump forming apparatus described above, a bump having a functional gradient from Cu which has resistance to migration to Au which is not liable to oxidation, is formed, but the functionally gradient material which can be generated by embodiments of the present invention is not limited to a functional gradient of this kind, and it is also possible to generate materials in which change is structured and controlled artificially.

More specifically, it is possible to generate a functionally gradient material in which the composition of elements constituting the material, the composition of the molecules, the crystalline structure, the molecular crystalline structure, the crystal orientation, the grain size, the grain boundaries, the bonding state, or the like, changes in a continuous or stepwise fashion.

A functional gradient may be generated from high thermal resistance to high mechanical adaptation (mechanical-compatibility), from insulating properties to conductivity, from a high refractive index to a low refractive index, from metal luster to low reflectivity, from high hardness to high adhesiveness, from biocompatibility to artificial object compatibility, from plasticity to high hardness, from hydrophobic properties to hydrophilic properties, and so on.

Furthermore, it is possible to create a component gradient from inorganic material to organic material, from high molecular weight to low molecular weight, from a high-density film to a low-density film, from a metallic material to an insulating material, and from magnetic to non-magnetic properties, and so on.

According to embodiments of the present invention, it is possible to generate a functionally gradient material in which the properties, function, composition, or the like, changes in a continuous or stepwise fashion from the lower layer to the upper layer, by using an inkjet head. Moreover, the functionally gradient material generated by embodiments of the present invention can be used as an electronic device component, a mechanical component, or a medical component.

### Base Material

In the present embodiment, a functionally gradient material is generated on a silicon wafer which is a flat plate-shaped member, but the base material is not limited to this.

For example, apart from a silicon wafer, it is also possible to use a glass plate or glass epoxy substrate, or a metal plate forming a mechanical component, or the like, as a rigid plate-shaped member.

Furthermore, it is possible to use an organic film made of PET (polyethylene terephthalate), PEN (polyethylene naphthalate), liquid crystal polymer, or the like, or paper such as inkjet-compatible paper, as a flexible plate-shaped member. If using a plate-shaped base material having flexibility of this kind, it is possible to generate a functionally gradient material by fixing the material to a drum used in a roll-to-roll system.

Moreover, it is also possible to use a base material which is a three-dimensional structure having a complicated shape, such as a lens forming an optical component, a front side or rear side of a frame such as a portable telephone, a mechanical component such as a gear, a toothed implant component, or the like. If using a three-dimensional base material, it is desirable to include a mechanism for keeping a uniform distance between the base material and the nozzles of the inkjet head. Furthermore, it is also possible to perform ink ejection in accordance with the shape of the base material. For example, in the case of a cylinder-shaped base material, it is possible to generate a functionally gradient material efficiently, by ejecting ink while rotating the base material.

In this way, the material may be glass, a semiconductor, a metal, or an organic material, or the like. It may also be a composite material such as a print substrate (glass epoxy substrate), or a laminated material such as inkjet-compatible paper.

Furthermore, the functionally gradient material which is generated may simply be formed as a film on the surface of a base material.

In the case of a solvent-type ink, the contents (micro-particles, and the like) can remain on the uppermost surface of the receiving layer and the solvent can be absorbed. For example, in the case of Ag nano-particle ink, there are situations where conductivity occurs at low temperature due to the effects on the dispersant in the Ag nano-particle ink when the solvent is absorbed in the receiving layer, and a heating process may not be necessary.

### State of Base Material and Image Formation Pre-Processing

In the case of a base material having lyophobic properties, it is difficult to form an image of a bottommost layer with functional ink. In situations like this, it is possible to modify the surface of the base material toward lyophilic properties, to such an extent that the functional ink is not repelled.

As a method of modifying the wetting properties in this way, it is possible to employ UV ozone processing, O₂ ashing, corona discharge processing, underlayer coating, thin film forming, and the like. Of these methods, it is possible to use an organic film such as polyimide, or a glass coat, or the like, for the underlayer.

Moreover, it is also possible to modify wetting properties by applying chemical processing. For instance, it is possible to achieve hydrophilization by immersing a polyethylene base material in a mixed solution of sulfuric acid and chromic acid. Moreover, it is possible to oxygen-modify and render the surface of a Teflon (registered trademark) base material, which has strong hydrophobic properties, hydrophilic properties by immersing the base material in a mixed Na/NH₃ solution.

Moreover, in various base materials, it is also possible to achieve affinity with organic solvents or rendering them hydrophilic properties, depending on the type of functional group, by means of a silane coupling agent.

Furthermore, in the case of a silicon base material, it is possible to achieve hydrophilization (hydrophilic properties) with respect to aqueous solutions by forming a thermal oxide film, and to achieve hydrophobization (give hydrophobic properties) by HF processing.

In the case of an organic film base material, it is possible to oxygen-modify and hydrophilize (give hydrophilic properties) the surface by performing UV irradiation processing using a quartz mercury lamp, or the like.

Furthermore, it is also possible to perform plasma surface processing. If plasma surface processing is carried out by introducing Ar, N₂, O₂, CF₄, C₂F₆, or another gas into a vacuum chamber, then it is possible to achieve hydrophilization and hydrophobization by means of a cleaning effect of removing oil from the surface or by means of a reaction with the surface. It is also possible to carry out plasma processing at atmospheric pressure, without using a vacuum chamber. In this case, since a vacuum is not used, then it is possible to modify the surface easily.

Moreover, it is also possible to achieve ultra-hydrophilic properties by forming a photocatalytic film, such as titanium oxide, or the like, by sol gelation, sputtering, plasma CVD, or the like, and irradiating ultraviolet light. By patterning the photocatalytic film and irradiating light selectively using a mask, it is also possible to obtain similar effects to when a hydrophilic and hydrophobic pattern is formed on the same single base material.

It is also possible to apply a layer for increasing adhesiveness with respect to the surface of the base material, as a further image formation pre-processing step. An organic material such as latex or a metal species having excellent adhesiveness can be employed, for instance.

Conversely, if the generated functionally gradient material is to be used as an independent small component, or is to be used by being transferred to another base material, then it is possible to apply processing for weakening the adhesiveness, in such a manner that the base material and the generated functionally gradient material can be separated readily.

In order to weaken the adhesiveness, the solution and the surface of the base material may be adjusted so as to make the surface less wettable, not to become completely lyophobic. This could be achieved by introducing a buffer layer (release layer). By previously coating the surface of the base material with a film forming a buffer layer which does not readily wet the base material and does not readily wet the functional ink either, the buffer layer and the base material are detached after the functionally gradient material has been generated.

For example, a thin film of polyethylene glycol organic film is formed on a base material, such as PET, and a functionally gradient material is formed using an aqueous functional ink.

In a case where a functionally gradient material is patterned in a particular portion of a base material, rather than being formed over the whole surface of the base material, then it is possible to perform lyophilic properties and lyophobic properties patterning beforehand on the surface of the base material, in such a manner that the functional ink adhering to the base material does not spill out significantly beyond the edges of the pattern.

Possible methods of the lyophobic properties and lyophilic properties patterning are printing techniques of various types, a photolithography technique, laser direct imaging, adapted photocatalyst technology, or the like, and it is also possible to use a suitable combination of these methods.

Moreover, in order to prevent the functional ink adhering on the base material from spilling out significantly beyond the edges of the pattern, it is also possible to provide a recess-shaped region created by a frame in advance before inkjet image formation, and to then perform image formation. In this case, the wetting properties may be raised previously by imparting lyophilic properties to the side faces of the frame. Moreover, the ink can be further prevented from spilling out by raising the lyophobic properties of the upper surface of the frame.

The base material may have a receiving layer, and this receiving layer may be patterned only in the places where it is required. Furthermore, these methods may be used conjointly.

### Lyophobic Processing Frame

If the ink in the upper layer drips off or spills out from the edges of the lower layer after forming the upper layer, then the height of the layer becomes uneven, and problems may arise in the functional material. In order to prevent a phenomenon of this kind, after forming the lower layer, it is possible to render the edge portions of the lower layer lyophobic with respect to the ink of the upper layer which is formed subsequently.

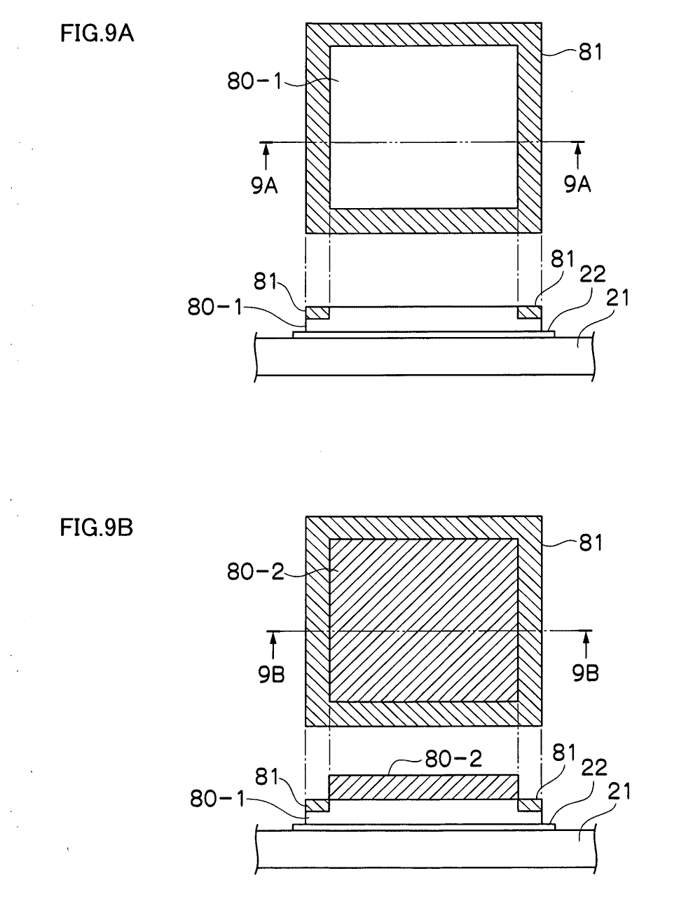

FIG. 9A shows a top plan diagram of a case where, after an ink layer 80-1 has been formed directly on an electrode 22 of an IC chip 21, a lyophobic processing section 81 is formed on the edge portions of the ink layer 80-1, and a cross-section along the broken line 9A-9A. Furthermore, FIG. 9B shows a top plan diagram of a case where an ink layer 80-2 has been formed subsequently on top of the ink layer 80-1, and a cross-section along the broken line 9B-9B.

As shown in FIGS. 9A and 9B, due to the presence of the lyophobic processing section 81 formed on the edge portions of the ink layer 80-1, the ink forming the ink layer 80-2 which has been ejected onto the surface of the ink layer 80-1 does not spill outside the lyophobic processing section 81. Therefore, it is possible to form an ink layer 80-2 appropriately on top of the ink layer 80-1.

In order to form the lyophobic processing section 81, it is possible to use patterning with a photo mask, direct laser imaging, laser scanning, or various printing techniques, such as inkjet patterning, screen printing, or the like.

By rendering the edge portions of the ink layer lyophobic in this way, it is possible to form a functionally gradient material having high accuracy.

### Edge Frame

In order to prevent the ink of the upper layer from dripping down or spilling out beyond the edge portions of the lower layer, it is also possible to carry out processing for providing a protruding frame in the edge portions, rather then lyophobic processing.

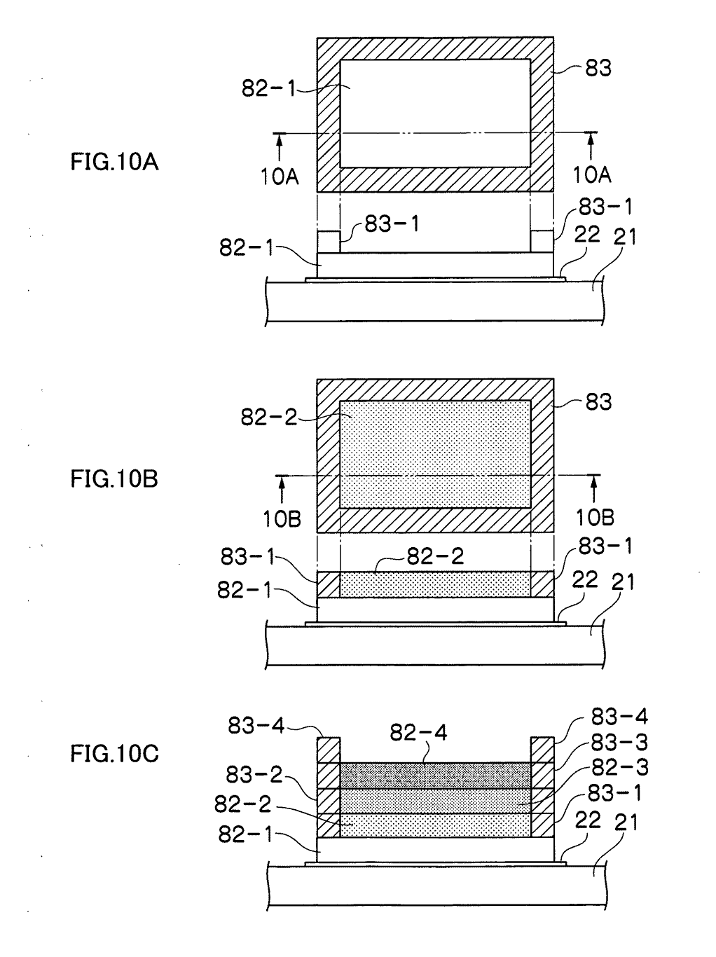

FIG. 10A shows a top plan diagram of a case where, after an ink layer 82-1 has been formed directly on an electrode 22 of an IC chip 21, an edge frame 83-1 is formed on the edge portions of the ink layer 82-1, and a cross-section along the broken line 10A-10A.

In forming the edge frame 83-1, it is possible to use various printing techniques, such as inkjet patterning, or screen printing, or the like. If inkjet patterning is used, then an effective method is one where a pattern is formed using a UV monomer ink, and exposure is performed immediately thereafter to cure the pattern.

Here, a “monomer ink” is an ink in which a functional monomer (polymerizable compound) is used as a principal component, and may contain a surfactant, a polymerization initiator, a polymerization prohibition agent, and a solvent other than monomers. Further, a monomer ink may contain dispersed particles such as pigments, metal nano-particles, and ceramic particles, and a functional polymer may be dissolved in a monomer ink.

FIG. 10B shows a top plan diagram of a case where an ink layer 82-2 has been formed on top of the ink layer 82-1 shown in FIG. 10A, and a cross-section along the broken line 10B-10B.

As shown in FIG. 10B, due to the presence of the edge frame 83-1 formed on the edge portions of the ink layer 82-1, the ink forming the ink layer 82-2 which has been ejected onto the surface of the ink layer 82-1 does not spill outside the edge frame 83-1. Therefore, it is possible to form an ink layer 82-2 appropriately on top of the ink layer 82-1.

Moreover, FIG. 10C is a cross-sectional diagram showing a case where, from the state shown in FIG. 10B, ink layers 82-3 and 82-4 have been formed while forming edge frames 83-2 and 83-3, and an edge frame 83-4 has also been formed.

Due to the presence of the edge frame 83-4, it is possible to form a further ink layer on top of the ink layer 82-4, without ink spilling out.

By providing a frame at the edge of each ink layer and successively forming an ink layer thereon in this way, then it is possible to form a functionally gradient material having high accuracy, even if there are a large number of ink layers or a complicated pattern.

### Combined Use of Spin Coating

When forming a functionally gradient material over the whole surface of a base material, for instance, it is possible to carry out spin coating after forming each layer, and before forming the next layer thereon. By this combined use of spin coating, the height of the layers is reduced, the layer thickness is adjusted, and the height of the layers on the surface of the base material can be made uniform. Furthermore, by combining use of inkjet technology, rather than forming a functionally gradient material simply by spin coating, it is possible to save liquid.

Spin coating may also be carried out after laminating all of the layers by an inkjet method. Consequently, there are cases where effects similar to those described above can be achieved.

### Semi-Drying

In embodiments of the present invention, when forming an upper side layer by ejecting ink onto a layer which has been formed on the lower side, it is important to dry (semi-dry) the lower layer to such an extent that the solvent component in the ink is not evaporated off completely.

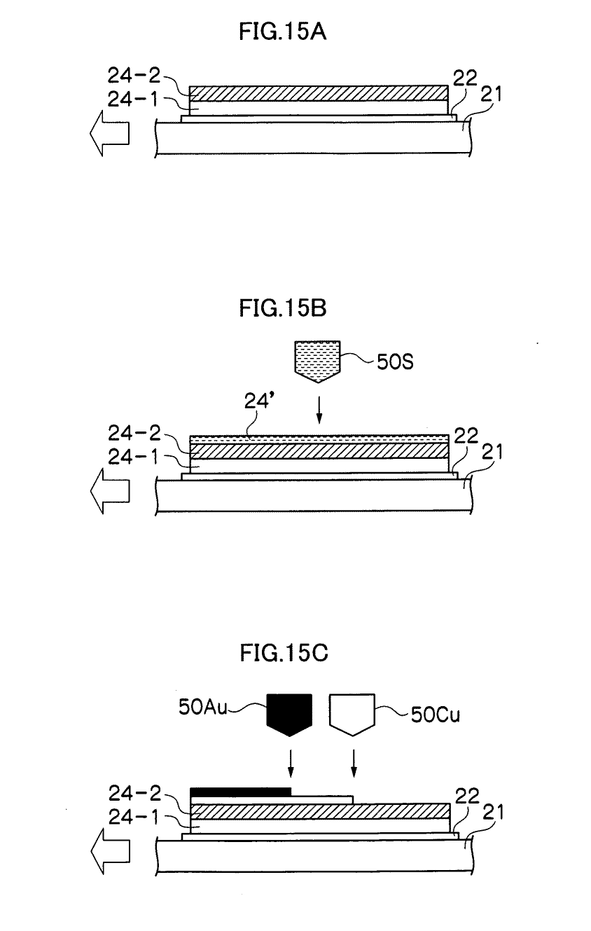

If ink having fast drying properties is used and the ink dries very quickly after ejection, then it is possible to provide a chemical treatment in order to reduce (alleviate) the extent of drying of the lower layer. When a mixed layer 24-2 is stacked on the Cu nano-particle ink layer 24-1, as shown in FIG. 15A, a chemical solution 24′ is applied to the surface of the mixed layer 24-2 from the inkjet head 50S, as shown in FIG. 15B, in order to suppress complete curing of the mixed layer 24-2.

In this way, the progress of drying of the mixed layer 24-2 is delayed compared to a case where the chemical solution 24′ is not applied, and the next layer can be formed while the mixed layer 24-2 remains in a desirable semi-dried state. FIG. 15C shows a state where Cu nano-particle ink and Au nano-particle ink for forming the next mixed layer are ejected onto the surface of the mixed layer 24-2.

For example, in the case a solvent-based ink is applied as the chemical solution 24′, it is possible to apply the ink solvent to the lower layer in advance or to immerse the lower layer in the solvent. Furthermore, the same solvent does not have to be used, and it is possible to use water or alcohol if the ink is an aqueous ink, or to use a solvent having similar polarity and molecular weight if the ink is a solvent-based ink.

Moreover, it is also possible to carry out the chemical treatment to reduce the drying of the lower layer, after the upper layer has been formed, rather than immediately before the upper layer is formed. Processing of this kind is effective since the liquid chemical also permeates also from the upper layer. Furthermore, it is possible to use the same solvent in the upper and lower layers, or to use a solvent which dissolves contents of the lower layer, in the ink of the upper layer.

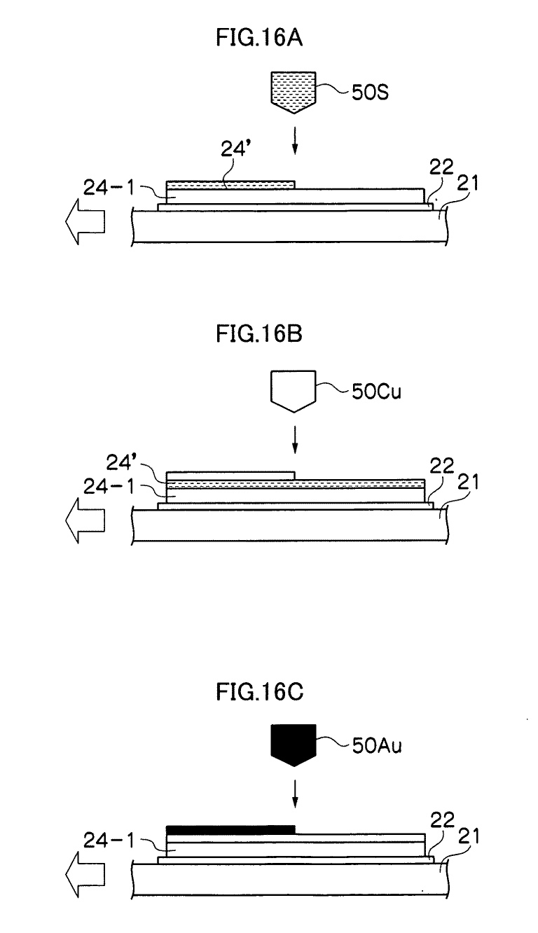

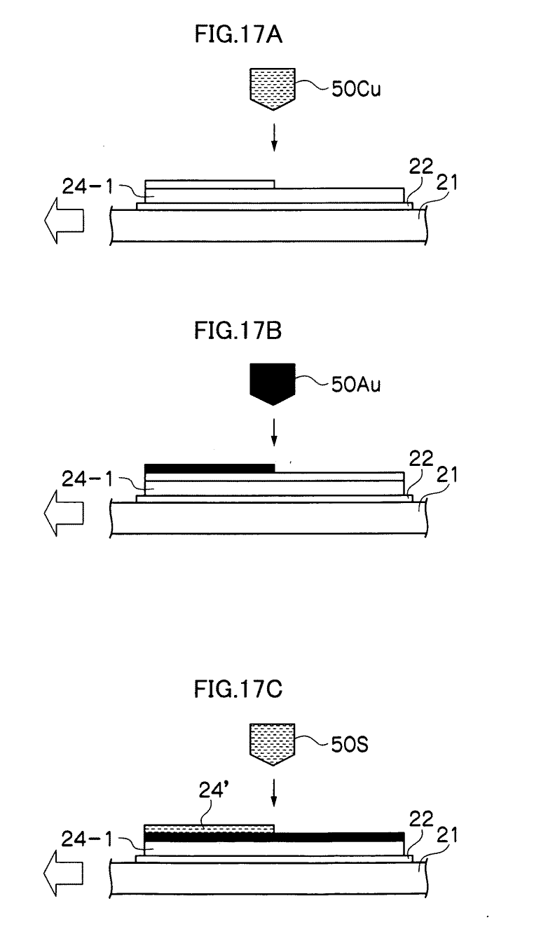

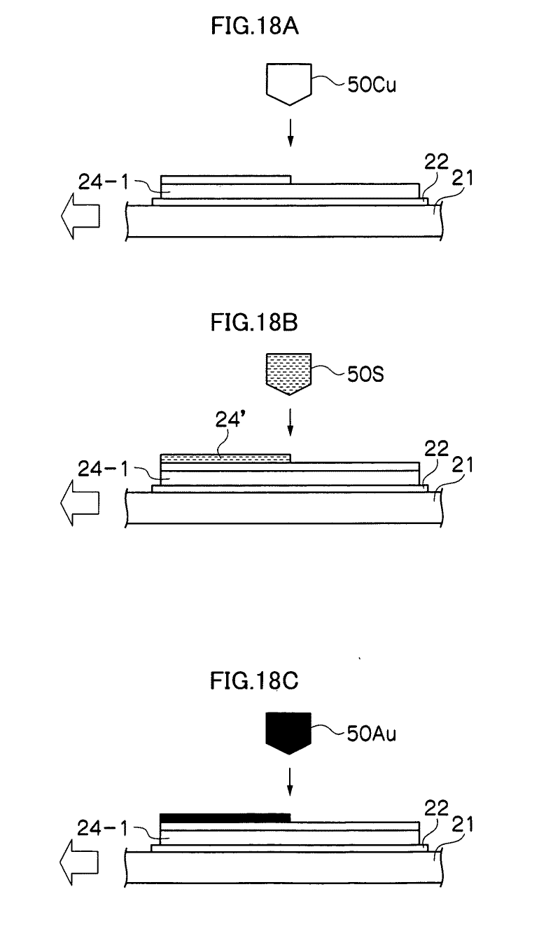

Furthermore, this chemical solution treatment promotes the diffusion between the plurality of inks (within layers) which constitute the mixed layers. FIGS. 16A to 18C are illustrative diagrams showing schematic views of chemical solution treatment processing according to different modes. FIGS. 16A to 16C show a mode where chemical solution is applied before forming a mixed layer; FIGS. 17A to 17C show a mode where chemical solution is applied after forming a mixed layer; and FIGS. 18A to 18C show a mode where chemical solution is applied during formation of a mixed layer.

FIG. 16A shows a state where a chemical solution 24′ is applied to the surface of a Cu nano-particle ink layer 24-1 from an inkjet head 50S. FIG. 16B shows a state where a chemical solution 24′ has been applied to the surface of a Cu nano-particle ink layer 24-1, and a Cu nano-particle ink is applied from the inkjet head 50Cu, and FIG. 16C shows a state where Cu nano-particle ink has been applied and Au nano-particle ink is applied from the inkjet head 50Au.

In the state shown in FIG. 16C, the chemical solution is received in the vicinity of the surface of the Cu nano-particle ink layer 24-1.

By applying a chemical solution 24′ before forming a mixed layer of Cu nano-particle ink and Au nano-particle ink in this way, drying of the Cu nano-particle ink and Au nano-particle ink is suppressed and diffusion of the Cu nano-particle ink and the Au nano-particle ink in the mixed layer can be promoted.

Furthermore, since the progress of drying of the lower layer (Cu nano-particle ink layer 24-1) is eased and diffusion between the layers also occurs in the vicinity of the interface with the mixed layer (upper layer), then adhesion between the lower layer and the upper layer is strengthened.

FIG. 17A shows a state where Cu nano-particle ink is applied from the inkjet head 50Cu to the surface of the Cu nano-particle ink layer 24-1, and FIG. 17B shows a state where Au nano-particle ink is applied from the inkjet head 50Au onto the Cu nano-particle ink.

FIG. 17C shows a state where Cu nano-particle ink and Au nano-particle ink forming a mixed layer have been applied, and then chemical solution 24′ is subsequently applied from an inkjet head 50S. By applying chemical solution 24′ after applying Cu nano-particle ink and Au nano-particle ink forming a mixed layer in this way, the drying of the Cu nano-particle ink and the Au nano-particle ink is suppressed (even supposing that drying of the Cu nano-particle ink and the Au nano-particle ink has progressed, the Cu nano-particle ink and the Au nano-particle ink are dissolved by the chemical solution), and it is possible to promote diffusion of Cu nano-particle ink and Au nano-particle ink in the mixed layer.

Furthermore, since the progress of drying of the mixed layer (the lower layer when forming the next mixed layer) is eased and a desirable semi-dried state is maintained, and furthermore due to the diffusion between layers which occurs in the vicinity of the interface with the upper layer which is formed next, the adhesion with the upper layer is strengthened.

FIG. 18A shows a state where a Cu nano-particle ink is applied to the surface of a Cu nano-particle ink layer 24-1 from an inkjet head 50Cu. FIG. 18B shows a state where a chemical solution 24′ is applied onto the Cu nano-particle ink from the inkjet head 50S, and FIG. 18C shows a state where Au nano-particle ink is applied onto the Cu nano-particle ink to which chemical solution 24′ has been applied, from the inkjet head 50Au.

In this way, by applying chemical solution 24′ during the formation of a mixed layer, drying of the Cu nano-particle ink and the Au nano-particle ink is suppressed, and diffusion of the Cu nano-particle ink and the Au nano-particle ink can be promoted in the mixed layer.

It is desirable to use an inkjet head to apply liquid chemical (chemical solution) of the kind described above. Since the chemical can be applied in the same apparatus, then there are beneficials in that the apparatus can be simple and only a small amount of chemical can be used due to the liquid saving features of the inkjet method.

Furthermore, the extent of drying of the solvent may be measured and used as feedback in the formation of the upper layer, when the formation of the lower layer has been completed or during the formation of the lower layer. For example, the roughness and reflection intensity of the layer can be measured with a laser, or the like, and be used to gauge the dryness.

It is also possible to provide a region which is not used as a functional material, or a separate dummy region for measurement, and to measure the extent of dryness by making contact with that region. Moreover, it is also possible to bring absorbing fibers or paper into contact with the film and to judge the extent of dryness by the extent of absorption of the solvent-based ink. Based on this judgment of the extent of dryness, the timing of the ejection for the next layer can be determined and further curing of the lower layer can be performed.

In the case of a UV monomer ink, or the like, which is cured by the irradiation of ultraviolet light, an amount of exposure light smaller than the amount of exposure light required to fully cure the ink may be irradiated onto the ink, so as to promote the diffusion of the upper and lower layers. Furthermore, curing of the UV monomer ink may be performed by exposing the whole of the layer after formation of the layer has been completed, or the droplets may be cured immediately after landing by using a compact UV exposure light source, such as a UV-LED, which can perform a scanning action (movement action) in accordance with the scanning of a head or stage concurrently.

Since the UV monomer ink has properties which make evaporation of solvent not liable to occur even if heated, then when using a monomer ink, it is possible to promote diffusion within the layers and between the layers by heating.

If forming a very fine pattern, a suitable method is one in which exposure is performed immediately after the droplets land. If using a UV monomer ink, it is also possible to measure the extent of dryness and the extent of solidification, similarly to the case of the solvent-based ink described above.

If a monomer ink, such as a UV monomer ink, is used, then a possible mode is one where the extent of curing is measured by using fluorescent light.

### Apparatus Composition of Image Formation Unit

In the present embodiment, a flat head type of inkjet image forming apparatus is used in the image formation unit, but the composition of the apparatus is not limited to this.

Firstly, the part on which the base material is set may be a drum or belt conveyance system, apart from a flat head type. Furthermore, the inkjet head and the base material may be moved relatively to each other. Consequently, the invention is not limited to a case where a base material is moved and a head is fixed in position, as in the present embodiment, and it is also possible to fix the base material in position and move an inkjet head in X and Y directions. Furthermore, it is also possible to combine these methods and to adopt a composition in which the inkjet head moves in one of the X and Y directions and the base material moves in the other of the X and Y directions.

Moreover, an image formation method for a functional ink may be a serial printer method or a line printer method. In order to form an image efficiently over a large surface area, it is suitable to employ a line printer method based on a single pass system. In a single pass system, it is possible to eject ink over the whole surface of each region of the base material where ink droplets are to be ejected, by passing the inkjet head and each region of the base material relatively just once.

Furthermore, the inkjet method may employ a continuous system or an on-demand system. If image formation is performed of a large surface area of several 10 cm square or greater, then an on-demand system having a plurality of nozzles is desirable.

Actuators which characterize the on-demand ejection method may employ various methods, such as a piezo method, a thermal method, a solid method, an electrostatic attraction method, or the like. A piezo method is also able to eject organic solvent-based materials, as well as aqueous materials, and is suited to the ejection of functional inks. Moreover, the nozzle arrangement may also be a single-row arrangement, a multiple-row arrangement, or a lattice arrangement (staggered arrangement).

On the other hand, if image formation is performed on a recess-shaped substrate, such as a substrate having a frame of height 1 mm or above, then a continuous system which has a relatively long flight distance is suitable. In a piezo method where the flight distance is relatively short, it is also possible to perform image formation while ensuring the flight distance by combining use of an electrostatic field between the head and the base material.

If the constituent materials of a functional ink include materials having a large grain size, then a head employing an electrostatic attraction method or an acoustic jet method, which has little possibility of nozzle blockages, is suitable.

If performing ejection while controlling the droplet volume to a very small droplet volume of not more than 1 picoliter, it is desirable to employ a head which ejects ink from a needle tip which is one type of electrostatic attraction method.

It is desirable to provide a deaeration module in a supply channel from an ink tank to an inkjet head. By using functional ink that has been deaerated, it is possible to stabilize ejection from an inkjet head.

Furthermore, it was confirmed by experimentation that, in a case where image formation at high density is performed at a dot pitch which is equal to or smaller than the diameter of droplets ejected from nozzles, if a liquid film is once formed by ejecting functional ink and then functional ink is ejected further onto the base material or liquid film, the occurrence of bubbles in the liquid film is reduced by using deaerated functional ink. The liquid film referred to here is a state where liquid droplets have been applied to a desired pattern region by image formation using an inkjet head and these droplets have joined together to create a film of liquid.

The deaeration method may employ a method where the ink is passed through a deaeration filter or a method where the ink is subjected to ultrasonic processing, or the like.

### Length of Inkjet Head

If forming a mixed layer by ejecting two inks in an image formation mixing method, desirably, the total length of the set of inkjet heads (the head length) is greater than one edge of the base material (long head), and each layer is formed by a single pass. In particular, if two inks are ejected sequentially as shown in FIGS. 6A to 6C, then the ink ejected second is desirably formed by a single pass. If a composition is adopted in which the ink ejected second is ejected in a divided fashion by performing a plurality of scanning actions of the inkjet head, then there is a possibility that a large amount of time passes between the first scanning action and the second scanning action, and a difference arises in the extent of diffusion. In order to prevent a phenomenon of this kind, ejection is performed in a single pass using a long head.

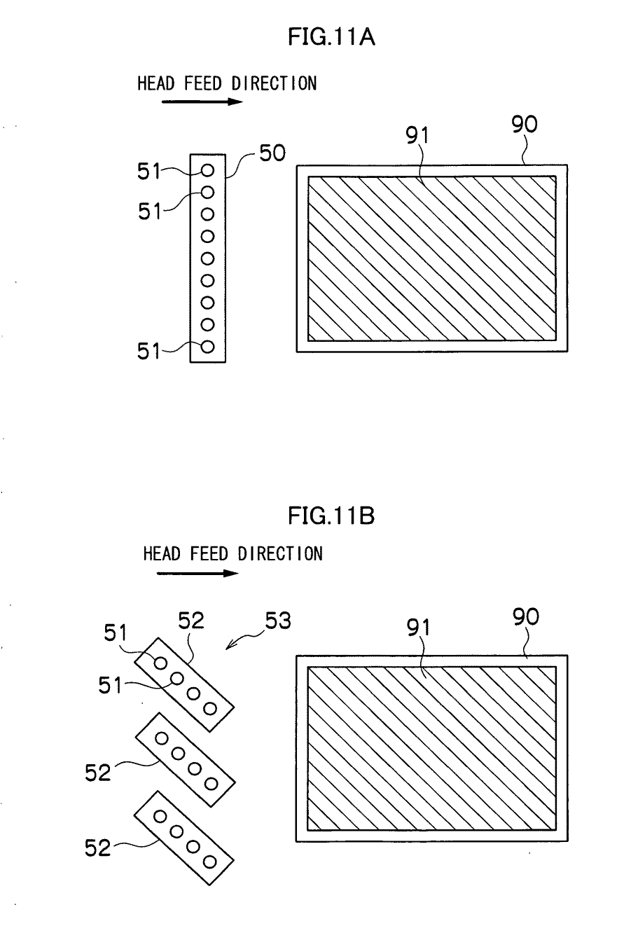

FIG. 11A is a schematic drawing showing the relationship, in the width direction, between a region 91 of functionally gradient material formed on the base material 90 and a head 50.

For example, as shown in FIG. 11A, it is desirable that the nozzles 51 of the head 50 should be arranged through a greater length than the width of the base material 90. By adopting a composition of this kind, it is possible to eject ink appropriately from the head 50 onto the region 91, by performing one relative movement of the head 50 and the base material 90 (single pass). Even if the head 50 is smaller than the width of the base material 90, the arrangement of nozzles 51 is desirably longer than the width of the region 91.

Moreover, if it is difficult to compose the head 50 as shown in FIG. 11A, due to the large size of the base material 90, or other reasons, then a head set 53 having a length covering the width of the base material 90 is composed by joining together a plurality of short head modules 52 as shown in FIG. 11B, and this head set 53 may be treated as a single head 50.

### Environment of Apparatus

It is desirable that each of the steps of the entire manufacturing process, such as the ejection of functional ink, the drying of the formed layer, the diffusion and mixing, and lastly the complete solidification and achievement of functionality, should be carried out in an atmosphere filled with inert gas.

If a lower layer is dried in air, then an oxidized surface layer much thinner than the formed layer may be generated. This oxidized surface layer may form an interface and create an obstacle when it is sought to create a certain extent of diffusion between upper and lower layers after a subsequent upper layer is formed. Furthermore, due to the occurrence of an unwanted interface, there may be possibilities, such as detachment from the interface, or the like.

Therefore, carrying out each process in an inert gas prevents formation of an oxidized surface layer and is effective in achieving a functionally gradient material. For the inert gas, it is possible to use nitrogen, helium, neon, argon, xenon, or the like.

### Countering the Coffee Stain Effect

In order to prevent a coffee stain effect, it is possible to combine two types of solvent having different boiling points in a functional ink. If a coffee stain effect occurs, the film thickness rises at the edges of a film, in a so-called “coffee ring”, the thickness within the layer becomes non-uniform, and problems may arise with regard to the functional material.

By forming a layer using a functional ink which combines solvents of two types having different boiling points, it is possible to alleviate the coffee stain effect.

### Composition of Sintering Unit

The device which dries or solidifies the ink in the sintering unit may employ heating by a hot plate or annealing oven, or the like, or besides this, irradiation of light by an infrared lamp, LED, laser, or the like, RTA (rapid thermal annealing) which performs instantaneous heating by condensing the light of a halogen lamp, heating by microwave, application of energy by an energy beam, or the like.

These drying methods, and the like, can be used either after the formation of each layer or after all of the layers have been laminated together.

Infrared heating or RTA, or the like, may arranged in the vicinity of the inkjet apparatus. Furthermore, it is also possible to omit an annealing oven and carry out drying in a vacuum state. By performing drying in a vacuum state, it is possible to prevent the occurrence of cracks. Moreover, it is also possible to carry out a pressurization process simultaneously, while heating by one of the methods described above, or the like. By this means, an effect in raising the density of the formed layer and an effect in assisting the achievement of functionality are obtained.

If using an ink which is cured by a chemical reaction (based on the application of activation energy) due to irradiation of ultraviolet light, such as a UV monomer ink, then it is desirable that UV light exposure (activation energy irradiation) should be performed.

### Countering Traces of Image Formation

Whether the image formation mixing method of the first embodiment or the mixed ink method of the second embodiment is employed, if using an ink having fast drying properties, there is a possibility of image formation traces occurring in the layer of ejected ink.

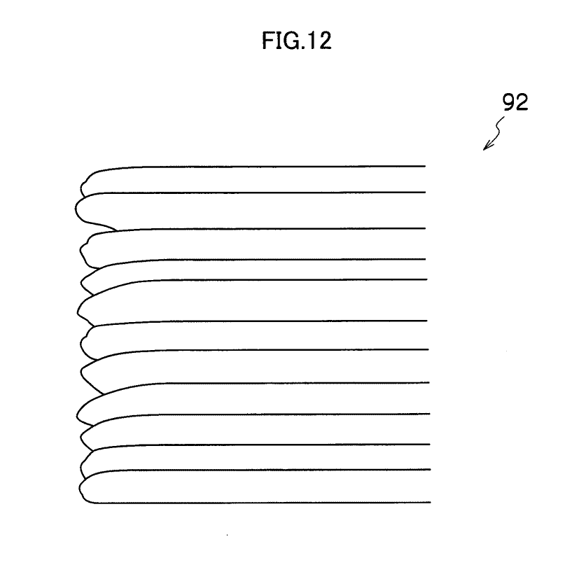

FIG. 12 shows an example where an ink layer 92 has been formed by ejecting ink from one nozzle in a raster scan from left to right and from top to bottom in the diagram, onto a base material which has been heated to approximately 60° C., using an organic solvent-based ink having a boiling point of approximately 160° C. When ink ejection onto one horizontal row has been completed and ink is then ejected onto one row below in this way, then if using an ink having fast drying properties, the previously ejected row may have dried and may have created an image formation trace when the next row is formed.

If image formation traces of this kind are produced, then there is significant anisotropy in the ink layer 92 depending on the direction of the image formation traces, and this is not desirable in terms of a functionally gradient material.

In order to reduce anisotropy of this kind, it is effective to change the scanning direction of the head and the base material.

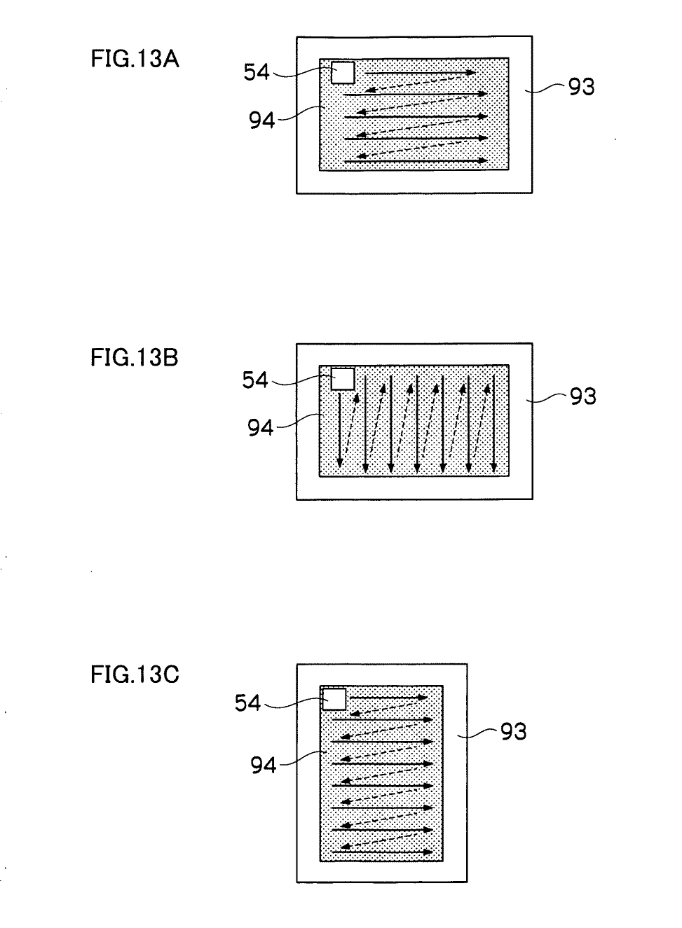

FIG. 13A is a schematic drawing showing the relationship of relative movement between an inkjet head 54 and a region 94 of a functionally gradient material formed on a base material 93. The inkjet head 54 and the base material 93 are moved relatively as indicated by the arrows in FIG. 13A, and functional ink is ejected from the inkjet head 54 to form an ink layer on the region 94. If using the apparatus shown in FIG. 3, the stage 30 is moved by the stage control unit 43.

In this case, if the functional ink ejected from the inkjet head 54 has fast drying properties, then image formation traces occur in the ink layer of the region 94, as shown in FIG. 12.

Consequently, when the ejection of ink onto the region 94 has been completed, ink ejection onto the region 94 is performed again after changing the direction of relative movement through 90° as shown in FIG. 13B. If using the apparatus shown in FIG. 3, the direction of movement of the stage 30 is changed by the stage control unit 43.

As shown in FIG. 13C, it is also possible to perform ink ejection again onto the region 94 by means of a raster scanning method in a similar direction, after changing the orientation of the base material 93 through 90°. If using the apparatus shown in FIG. 3, it is desirable that, after rotating the stage 30 through 90°, ink should be ejected while performing relative movement in the same direction as that indicated in FIG. 13A.

The same also applies in an apparatus composed in such a manner that the inkjet head 54 moves, rather than the base material 93 side, and it is possible to change the direction of movement of the inkjet head 54 or to rotate the stage 30 through 90° without altering the direction of movement of the inkjet head 54.

In this way, by forming one layer by ejecting ink while performing relative movement and then further ejecting ink while performing relative movement in a direction having a difference of 90°, then it is possible to reduce anisotropy even if image formation traces occur. Here, the direction of relative movement is changed through 90°, but it may be changed through approximately 90°.

### Generation of Functionally Gradient Material by Means of Different Components

In the present embodiment, a functionally gradient material composed by components of two types is generated, but the number of components is not limited to two types only. For example, there are cases where functionality as a functionally gradient material is not displayed simply by mixing functional inks.

In cases such as this, for instance, a case where conductivity and biological characteristics are respectively changed gradually, it is possible to form each layer by passing via different components, such as Ag→Au→Pt→Ti. (i.e. Ag, Au, Pt and Ti in that order). In this way, the present invention can be used even to generate a functionally gradient material having components of many types.

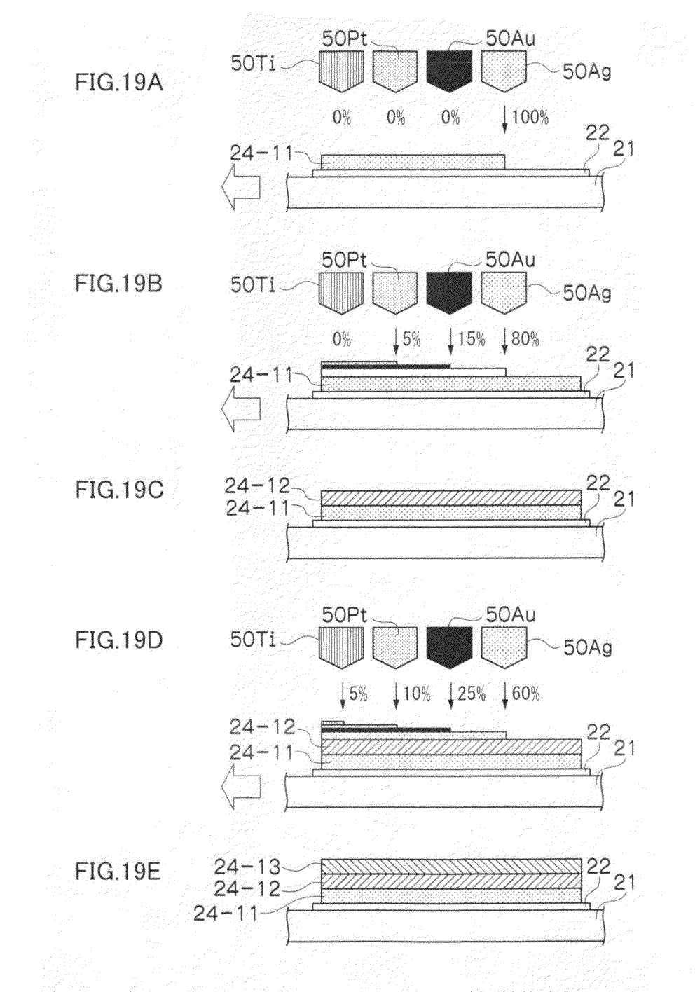

FIGS. 19A to 19E are illustrative diagrams showing schematic views of a mode where a functionally gradient material formed by components of four types is generated by an image formation mixing method. Ag, Au, Pt and Ti are used as the components of four types, and Ag nano-particle ink, Au nano-particle ink, Pt nano-particle ink and Ti nano-particle ink are ejected respectively from an inkjet head 50Ag, an inkjet head 50Au, an inkjet head 50Pt and an inkjet head 50Ti.

FIG. 19A shows a schematic diagram of an Ag nano-particle ink layer forming step in which an Ag nano-particle ink layer 24-11 forming a bottommost layer is formed by Ag nano-particle ink. In the Ag nano-particle ink layer forming step, Ag nano-particle ink is ejected from the inkjet head 50Ag, and ink is not ejected from the inkjet head 50Au, the inkjet head 50Pt and the inkjet head 50Ti.

FIG. 19B is a schematic view of a step of forming a mixed layer 24-12 on the surface of the Ag nano-particle ink layer 24-11. The respective inks are ejected at a ratio of 80% Ag nano-particle ink, 15% Au nano-particle ink, 5% Pt nano-particle ink and 0% Ti nano-particle ink, and the inks are sufficiently diffused and mixed together.

FIG. 19C shows a schematic view of a state where a mixed layer (having a mix ratio of 80:15:5:0 for the Ag nano-particle ink, Au nano-particle ink, Pt nano-particle ink, Ti nano-particle ink) 24-12 has been formed on top of the Ag nano-particle ink layer 24-11.

FIG. 19D shows a schematic view of a step of forming a mixed layer 24-13 (see FIG. 19E) which is laminated on the mixed layer 24-12 formed previously.

In the mixed layer forming step shown in FIG. 19D, the respective inks are ejected at a ratio of 60% Ag nano-particle ink, 25% Au nano-particle ink, 10% Pt nano-particle ink and 5% Ti nano-particle ink, and the inks are sufficiently diffused and mixed together.

FIG. 19E shows a schematic view of a state where a mixed layer 24-13 having a different mix ratio has been laminated onto the mixed layer 24-12. In this way, a functionally gradient material is formed while suitably changing the mix ratio of the inks of four types.

It is possible to adopt a mode where the uppermost layer and the bottommost layer of the functionally gradient material are mixed layers, or a mode where the mix ratio of all of the components does not increase or decrease monotonously (for example, a mode where a portion of the components has a fixed mix ratio, or a mode where the mix ratio both increases and decreases).

In FIGS. 19A to 19E, a mode is described in which a functionally gradient material using components of four types (three or more types) is generated in an image formation mixing method, but it is of course possible to generate a functionally gradient material by using components of three or more types in an ink mixing method.

### Other Modification Examples

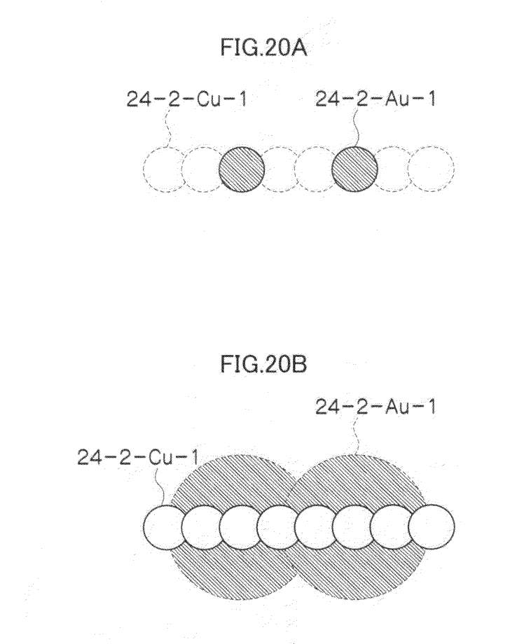

FIGS. 20A and 20B are illustrative diagrams of a mode where, when generating a functionally gradient material using components of two types, the component having a smaller volume ratio (Au nano-particle ink) is applied first and the component having a larger volume ratio is applied subsequently.

The dots 24-2-Au-1 indicated by the diagonal hatching in FIG. 20A are dots formed by Au nano-particle ink which is applied first. On the other hand, the dots 24-2-Cu-1 indicated by the broken line are virtual dots formed by Cu nano-particle ink that is to be applied after applying the Au nano-particle ink.

The volume ratio of the Au nano-particle ink to Cu nano-particle ink is 2:8, and the numerical quantity ratio between the dots 24-2-Au-1 formed by Au nano-particle ink and the dots 24-2-Cu-1 formed by Cu nano-particle ink is specified by this ratio.

Although not illustrated, dots 24-2-Cu-1 made by Cu nano-particle ink are formed at the same droplet ejection positions as the dots 24-2-Au-1 made by Au nano-particle ink.

FIG. 20B shows a situation where Cu nano-particle ink is applied in a state where the dots 24-2-Au-1 formed by the Au nano-particle ink applied previously have wet and spread sufficiently.

In this way, the dots 24-2-Au-1 formed by Au nano-particle ink applied previously wet and spread sufficiently and become sufficiently thin, and therefore the dots 24-2-Au-1 formed by Au nano-particle ink and the dots 24-2-Cu-1 formed by Cu nano-particle ink diffuse and mix in the thickness direction as the dots 24-2-Cu-1 formed by the Cu nano-particle ink wet and spread. Consequently, it is possible to shorten the time required for diffusion and mixing.

In order to improve the wetting properties of the dots 24-2-Au-1 formed by the Au nano-particle ink applied previously, it is desirable to perform modification (improvement) processing on the electrode 22 (under layer), and to add a component which improves wetting properties to the Au nano-particle ink.

It is desirable that a plurality of inks which correspond to a plurality of components forming the functionally gradient material should be applied successively in order of descending surface tension (surface energy). If an ink having a relatively small surface tension is applied first and an ink having a relatively large surface tension is applied subsequently, then the ink having a relatively large surface tension which is applied subsequently does not diffuse and mix sufficiently and a distribution of components in the layer occurs.

Furthermore, although not shown in the drawings, if the ink applied subsequently is formed in an image at the densest fill ratio (closest packing, hexagonal configuration), then it is possible to shorten the time required for diffusion and mixing.

Methods and apparatuses for manufacturing a functionally gradient material relating to embodiments of the present invention which have been described above can be modified appropriately within a range that does not depart from the essence of the present invention.

### Appendix

As has become evident from detailed description of the embodiments given above, the present specification includes disclosure of various technical ideas including a plurality of aspects of the invention described below.

One aspect of the present invention is directed to a method of manufacturing a functionally gradient material having a gradient from a first material to a second material different to the first material by ejecting inks onto a base material from a plurality of inkjet heads, the method comprising: a first supply step of supplying a first functional ink containing the first material to a first inkjet head; a second supply step of supplying a second functional ink containing the second material to a second inkjet head; a control step of specifying a ratio between a volume of the first functional ink ejected from the first inkjet head and a volume of the second functional ink ejected from the second inkjet head; a forming step of causing the first inkjet head to eject the first functional ink and/or causing the second inkjet head to eject the second functional ink, in accordance with the specified ratio, so as to form one layer; and a laminating step of stacking a plurality of layers onto the base material by repeating the forming step, so as to obtain a laminated body, wherein in the control step, the ratio between the first functional ink and the second functional ink is specified in such a manner that respective layers of the plurality of layers progressively have a smaller ratio of the first functional ink and a larger ratio of the second functional ink, toward an upper layer.

According to this aspect of the invention, the ratio between the volume of a first functional ink ejected from a first inkjet head and the volume of a second functional ink ejected from a second inkjet head is specified, a plurality of layers are laminated onto a base material by repeating a step of forming one layer by ejecting the inks in accordance with the specified ratio, and the respective layers of the plurality of layers progressively have a smaller ratio of the first functional ink and a larger ratio of the second functional ink, toward the upper layer. Therefore, it is possible to manufacture a functionally gradient material using inkjet technology.

In this aspect of the present invention, the ratio between the first functional ink and the second functional ink may be 100% of the first functional ink or 100% of the second functional ink.

Also possible are a mode where the functionally gradient material according to this aspect of the present invention uses a third functional ink containing a third functional material which is different to the first material and the second material or a mode where the functionally gradient material according to this aspect of the present invention uses a fourth functional ink containing a fourth functional material which is different to the first, second and third materials.

In other words, the method of manufacturing a functionally gradient material relating this aspect of the present invention is characterized in that a liquid film is formed on a base material using one type or two or more types of functional inks, the mix ratio of the functional inks being changed in continuous fashion so as to superimpose together liquid films having different mix ratios of the functional inks, thereby generating a functionally gradient material having a gradient in the mix ratio of the functional inks in the thickness direction of the liquid films from the base material.

Desirably, in the forming step, of the first functional ink and the second functional ink, an ink having higher surface tension is ejected first and an ink having lower surface tension is ejected subsequently to form a layer made of a mixed ink of the first functional ink and the second functional ink.

According to this mode, diffusion and mixing of the first functional ink and the second functional ink applied to the base material occurs reliably.

Desirably, the forming step comprises: a first intermittent ejection step of performing intermittent ejection of the first functional ink to dispose dots of the first functional ink discretely; a second intermittent ejection step of ejecting the second functional ink intermittently toward same positions as the discretely disposed dots of first functional inks; a first interpolating ejection step of ejecting the first functional ink so as to interpolate between the discretely disposed dots of the first functional ink, after the second intermittent ejection step; and a second interpolating ejection step of ejecting the second functional ink toward same positions as the dots of the first functional inks ejected in the first interpolating ejection step.

According to this mode, by arranging the first functional ink discretely, landing interference of the first functional ink is prevented, and since discretely arranged second functional ink is arranged at the same positions as the discretely arranged first functional ink, then it is possible to cause the first functional ink and the second functional ink to diffuse and mix in droplet units, at these same positions.

In this mode, there is a case where the ink having a larger volume ratio is taken as the first functional ink and the ink having a smaller volume ratio is taken as the second functional ink. Also possible is a mode where the ejection volume of the first functional ink and the ejection volume of the second functional ink in one ejection action is varied in accordance with the volume ratio.

Desirably, the laminating step includes a first subsidiary ink disposition step of disposing a first subsidiary ink which promotes diffusion of the first material or the second material in a mixed layer of the first functional ink and the second functional ink.

According to this mode, diffusion of the first and second functional inks in a layer is promoted, a desirable mixed layer of first and second functional inks can be formed.

Desirably, the first subsidiary ink deposition step, the first subsidiary ink is disposed before forming the mixed layer of the first functional ink and the second functional ink.

According to this mode, mixing of the first and second functional inks is promoted in order to form a mixed layer of the first and second functional inks, and insufficient mixing of the first and second functional inks is prevented.

Desirably, in the first subsidiary ink deposition step, the first subsidiary ink is disposed after the first functional ink for forming the mixed layer of the first functional ink and the second functional ink is disposed but before the second functional ink is disposed.

According to this mode, drying of an ink disposed in first is suppressed, and mixing of the first and second functional inks is promoted.

Desirably, in the first subsidiary ink deposition step, the first subsidiary ink is disposed after forming the mixed layer of the first functional ink and the second functional ink.

According to this mode, diffusion of an ink disposed subsequently is suppressed, and mixing of the first and second functional inks is promoted.

Desirably, the forming step includes a first functional ink layer forming step of forming a layer of the first functional ink, and a curing step of completely curing the layer of the first functional ink; and in the first subsidiary ink deposition step, the first subsidiary ink is disposed after the first functional ink layer forming step.

In this mode, the term “completely curing” means a state where a layer is cured in such a manner that it does not dissolve even if the first subsidiary ink is provided.

Desirably, the method of manufacturing a functionally gradient material, further comprises an improvement treatment step of performing an improvement treatment of a surface of the base material onto which the first functional ink and the second functional ink are disposed, wherein in the forming step, of the first functional ink and the second functional ink, an ink having a smaller volume ratio is ejected first to form the layer made of the first functional ink and the second functional ink.

According to this mode, since the ink having the larger ratio is disposed after the ink having the smaller ration has wetly spread sufficiently, mixing of the first and second functional inks is promoted in terms of the thickness direction, which can shorten the time period for the diffusion and mixing.

Desirably, in the forming step, of the first functional ink and the second functional ink, an ink having a larger volume ratio is ejected first, in order to form a layer of the first functional ink and the second functional ink.

According to this mode, wet spreading of the first or second functional ink is promoted on the base material. Further, this mode can prevent the first and second functional inks from not diffusing and mixing due to drying of an ink ejected in first.

Desirably, the method of manufacturing a functionally gradient material further comprises a diffusion mixing step of diffusing and mixing the first functional ink ejected from the first inkjet head and the second functional ink ejected from the second inkjet head on the base material.

According to this mode, a layer in which two functional inks have diffused and mixed sufficiently can be formed.

Desirably, the diffusion mixing step includes an ultrasonic step of performing ultrasonic processing of the base material.

According to this mode, it is possible to diffuse and mix a plurality of functional inks having different ratios, and improved efficiency of the diffusion and mixing step is expected.

Desirably, in the forming step, the first functional ink and the second functional ink are ejected in such a manner that the ink ejected from one of the first inkjet head and the second inkjet head is deposited at a position where the ink from the other inkjet head is disposed.

According to this mode, the time period required for the diffusion and mixing of the first and second functional inks can be shortened.

Another aspect of the present invention is directed to a method of manufacturing a functionally gradient material having a gradient from a first material to a second material different to the first material by ejecting inks onto a base material from a plurality of inkjet heads, the method comprising: a supply step of supplying a plurality of inkjet heads respectively with a plurality of mixed inks in which a first functional ink containing the first material and a second functional ink containing the second material are mixed at respectively different mix ratios; a selection step of selecting one inkjet head in order from the plurality of inkjet heads according to a ration of the first functional ink, the inkjet head being selected in order from an inkjet head to which a mixed ink having a highest ratio of the first functional ink is supplied; a forming step of causing the selected inkjet head to eject the mixed ink so as to form one layer; and a laminating step of stacking a plurality of layers onto the base material by repeating the forming step, so as to obtain a laminated body.

According to this aspect, since a plurality of mixed inks which combine a first functional ink and a second functional ink and have respectively different ratios of the first functional ink and the second functional ink are supplied to respective inkjet heads, and layers are formed by ejecting the mixed inks successively in order starting from the inkjet head to which the mixed ink having the highest ratio of the first functional ink is supplied, so as to laminate a plurality of layers onto the base material, then it is possible to manufacture a functionally gradient material using inkjet technology.

The mixed ink according to this aspect of the present invention may have a mix ratio of 100:0 or a mix ratio of 0:100, between the first functional ink and the second functional ink.

Desirably, in the forming step, one layer is formed by the mixed ink while relatively moving the base material and the plurality of inkjet heads a plurality of times, the mixed ink being arranged discretely by one relative movement of the base material and the plurality of inkjet heads, and interpolation between discretely arranged positions of the mixed ink being performed by the plurality of relative movements of the base material and the plurality of inkjet heads.

According to this mode, by preventing landing interference when forming one layer, it is possible to prevent the occurrence of a coffee stain where the layer deforms in a circular ring shape due to deformation of the ink (dot) shape caused by landing interference.

Desirably, the forming step includes a semi-drying step of semi-drying each formed layer after each layer has been formed.

According to this mode, diffusion occurs in the vicinity of the interfaces between the respective layers, and it is possible to improve adhesion between the layers.

Desirably, the laminating step includes, after forming a mixed layer of the first functional ink and the second functional ink, a second subsidiary ink disposition step of disposing a second subsidiary ink causing diffusion in a vicinity of a boundary between the formed layer and a layer formed subsequently.

According to this mode, the adhesive properties between a layer formed first and a layer formed subsequently can be improved. The first and second subsidiary inks can be commonalized.

Desirably, the plurality of layers include a mixed ink which only contains the first functional ink and does not contain the second functional ink and/or a mixed ink which only contains the second functional ink and does not contain the first functional ink.

According to this mode, a layer containing the first material only and/or a layer containing the second material only can be formed.

Desirably, in the semi-drying step, drying is delayed if drying of the formed layer is fast.

According to this mode, even if using an ink which dries quickly, it is possible to keep the ink in a semi-dried state by restricting the progress of drying, and diffusion in the vicinity of the interfaces between the layers can be promoted.

For example, it is also possible to adopt a mode which includes a step of ejecting liquid chemical containing a solvent of the first functional ink or a solvent of the second functional ink.

Desirably, the method of manufacturing a functionally gradient material further comprises a measurement step of measuring an extent of drying of the formed layer, wherein in the semi-drying step, each formed layer is semi-dried according to the measured extent of drying.

According to this mode, it is possible to set the ink to a semi-dried state appropriately.

The measuring step in this mode may perform measurement after formation of the layer has been completed, or during layer formation.

A dummy region for measurement and a region that is not used as a functionally gradient material, may be provided.

Desirably, the method of manufacturing a functionally gradient material further comprises a lyophobization step of rendering an outer perimeter portion of each formed layer lyophobic with respect to an ink to be ejected subsequently, after each layer is formed.

According to this mode, it is possible to prevent the ink ejected subsequently from spilling out beyond the lower layer.

Desirably, the method of manufacturing a functionally gradient material further comprises a frame generating step of providing a frame for surrounding an ink to be ejected subsequently, at an outer perimeter portion of each formed layer, after each layer is formed.

According to this mode, it is possible to prevent the ink ejected subsequently from spilling out beyond the lower layer.

Desirably, the method of manufacturing a functionally gradient material further comprises a lyophilic step of rendering the ink ejected first onto a surface of the base material lyophilic properties, before the forming step.

According to this mode, a layer being to be formed first directly on the base material can be formed in an appropriate fashion.

Desirably, each of the steps is carried out in an inert gas atmosphere.

According to this mode, the oxidation of the respective formed layers can be prevented.

Desirably, the method of manufacturing a functionally gradient material further comprises a sintering step of sintering the laminated body at a prescribed sintering temperature.

According to this mode, the appropriate laminated body can be formed.

It is also possible to adopt a mode which includes a curing step of fully curing the laminated body by applying curing energy to the laminated body which has been obtained.

According to this mode, diffusion is promoted in the vicinity of the interfaces between the respective layers as the layers crystallize, and the plurality of layers which have been formed in a stepwise fashion become continuous, and a suitable laminated body can be formed.

The curing step in this mode may include a mode where the laminated body is cured by application of thermal energy (sintering step), and a mode where the laminated body is cured by application of an active light beam, such as ultraviolet light, or the like.

Another aspect of the present invention is directed to an apparatus for manufacturing a functionally gradient material having a gradient from a first material to a second material different to the first material by ejecting inks onto a base material from a plurality of inkjet heads, the apparatus comprising: a first inkjet head which ejects a first functional ink containing the first material; a second inkjet head which ejects a second functional ink containing the second material; a control device which controls a volume of the first functional ink ejected from the first inkjet head and a volume of the second functional ink ejected from the second inkjet head; a forming device which causing the first inkjet head and the second inkjet head to eject the first functional ink and the second functional ink so as to form one layer; and a laminating device which obtains a laminated body by stacking a plurality of layers by the forming device, wherein the control device specifies a ratio between the first functional ink and the second functional ink in such a manner that respective layers of the plurality of layers progressively have a smaller ratio of the first functional ink and a larger ratio of the second functional ink, toward an upper layer.

According to this aspect of the invention, the ratio between the volume of a first functional ink ejected from a first inkjet head and the volume of a second functional ink ejected from a second inkjet head is specified, a plurality of layers are superimposed onto a base material by forming a layer by ejecting ink in accordance with the specified ratio, and the respective layers of the plurality of layers progressively have a smaller ratio of the first functional ink and a larger ratio of the second functional ink, toward the upper layer. Therefore, it is possible to manufacture a functionally gradient material using inkjet technology.

Desirably, the apparatus for manufacturing a functionally gradient material further comprises a movement device which causes relative movement in a prescribed direction between the base material and at least one of the first inkjet head and the second inkjet head, wherein: the at least one of the first inkjet head and the second inkjet head has a plurality of nozzles for ejecting ink droplets which are arranged through a whole range of a layer to be formed on the base material, in a direction perpendicular to the prescribed direction; and the forming device forms one layer during one relative movement of the first inkjet head and the second inkjet head by the movement device.

According to this mode, it is possible to form respective layers efficiently using a single-pass method in which a first functional ink and a second functional ink are applied to the whole area of a base material while relatively moving a first inkjet head and a second inkjet head, and the base material, just once.

Desirably, the apparatus for manufacturing a functionally gradient material further comprises: a movement device which causes relative movement between the base material and at least one of the first inkjet head and the second inkjet head; and a changing device which changes a direction of the relative movement through approximately 90 degrees, wherein the forming device causes an ink to be ejected during the relative movement by the movement device, whereupon the direction of the relative movement is changed through 90 degrees by the changing device, and the forming device then causes an ink to be ejected again during the relative movement by the movement device.

According to this mode, it is possible to prevent the occurrence of anisotropy caused by image formation traces.

Another aspect of the present invention is directed to an apparatus for manufacturing a functionally gradient material having a gradient from a first material to a second material different to the first material by ejecting inks on a base material from a plurality of inkjet heads, the apparatus comprising: a supply device which supplies the plurality of inkjet heads respectively with a plurality of mixed inks in which a first functional ink containing the first material and a second functional ink containing the second material are mixed at respectively different mix ratios; a selection device which selects one inkjet head in order from the plurality of inkjet heads according to a ration of the first functional ink, the inkjet head being selected in order from an inkjet head to which a mixed ink having a highest ratio of the first functional ink is supplied a forming device which causes the selected inkjet head to eject the mixed ink so as to form one layer; and a laminating device which obtains a laminated body by stacking a plurality of layers on the base material by repeating formation of the layer by the forming device.

According to this aspect of the invention, since a plurality of mixed inks which combine a first functional ink and a second functional ink and have respectively different ratios of the first functional ink and the second functional ink are supplied to respective inkjet heads, and layers are formed by ejecting the mixed inks successively in order starting from the inkjet head to which the mixed ink having the highest ratio of the first functional ink is supplied, so as to superimpose a plurality of layers onto the base material, then it is possible to manufacture a functionally gradient material using inkjet technology.

Desirably, the forming device forms one layer by a continuous type of inkjet method.

According to this mode, it is possible to form respective layers appropriately, even on a recess-shaped base material.

Desirably, the first inkjet head and the second inkjet head employ a piezo method; and the apparatus further comprises an electric field application device which applies an electric field for increasing a distance of flight of ejected inks.

According to this mode, it is possible to form respective layers appropriately, while increasing the distance of flight of the ink.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of manufacturing a functionally gradient material having a gradient from a first material to a second material different to the first material by ejecting inks onto a base material from a plurality of inkjet heads, the method comprising:
a first supply step of supplying a first functional ink containing the first material to a first inkjet head;
a second supply step of supplying a second functional ink containing the second material to a second inkjet head;
a control step of specifying a ratio between a volume of the first functional ink ejected from the first inkjet head and a volume of the second functional ink ejected from the second inkjet head;
a forming step of causing the first inkjet head to eject the first functional ink and/or causing the second inkjet head to eject the second functional ink, in accordance with the specified ratio, so as to form one layer; and
a laminating step of stacking a plurality of layers onto the base material by repeating the forming step, so as to obtain a laminated body,
wherein in the control step, the ratio between the first functional ink and the second functional ink is specified in such a manner that respective layers of the plurality of layers progressively have a smaller ratio of the first functional ink and a larger ratio of the second functional ink, toward an upper layer.

2. The method of manufacturing a functionally gradient material as defined in claim 1, wherein in the forming step, of the first functional ink and the second functional ink, an ink having higher surface tension is ejected first and an ink having lower surface tension is ejected subsequently to form a layer made of a mixed ink of the first functional ink and the second functional ink.

3. The method of manufacturing a functionally gradient material as defined in claim 1, wherein the forming step comprises:
a first intermittent ejection step of performing intermittent ejection of the first functional ink to dispose dots of the first functional ink discretely;
a second intermittent ejection step of ejecting the second functional ink intermittently toward same positions as the discretely disposed dots of first functional inks;
a first interpolating ejection step of ejecting the first functional ink so as to interpolate between the discretely disposed dots of the first functional ink, after the second intermittent ejection step; and
a second interpolating ejection step of ejecting the second functional ink toward same positions as the dots of the first functional inks ejected in the first interpolating ejection step.

4. The method of manufacturing a functionally gradient material as defined in claim 1, wherein, in the forming step, the first functional ink and the second functional ink are ejected in such a manner that the ink ejected from one of the first inkjet head and the second inkjet head is deposited at a position where the ink from the other inkjet head is disposed.

5. The method of manufacturing a functionally gradient material as defined in claim 1, wherein the laminating step includes a first subsidiary ink disposition step of disposing a first subsidiary ink which promotes diffusion of the first material or the second material in a mixed layer of the first functional ink and the second functional ink.

6. The method of manufacturing a functionally gradient material as defined in claim 5, wherein in the first subsidiary ink deposition step, the first subsidiary ink is disposed before forming the mixed layer of the first functional ink and the second functional ink.

7. The method of manufacturing a functionally gradient material as defined in claim 5, wherein in the first subsidiary ink deposition step, the first subsidiary ink is disposed after the first functional ink for forming the mixed layer of the first functional ink and the second functional ink is disposed but before the second functional ink is disposed.

8. The method of manufacturing a functionally gradient material as defined in claim 5, wherein in the first subsidiary ink deposition step, the first subsidiary ink is disposed after forming the mixed layer of the first functional ink and the second functional ink.

9. The method of manufacturing a functionally gradient material as defined in claim 1, further comprising an improvement treatment step of performing an improvement treatment of a surface of the base material onto which the first functional ink and the second functional ink are disposed,
wherein in the forming step, of the first functional ink and the second functional ink, an ink having a smaller volume ratio is ejected first to form the layer made of the first functional ink and the second functional ink.

10. The method of manufacturing a functionally gradient material as defined in claim 1, wherein in the forming step, of the first functional ink and the second functional ink, an ink having a larger volume ratio is ejected first, in order to form a layer of the first functional ink and the second functional ink.

11. The method of manufacturing a functionally gradient material as defined in claim 1, further comprising a diffusion mixing step of diffusing and mixing the first functional ink ejected from the first inkjet head and the second functional ink ejected from the second inkjet head on the base material.

12. The method of manufacturing a functionally gradient material as defined in claim 11, wherein the diffusion mixing step includes an ultrasonic step of performing ultrasonic processing of the base material.

13. A method of manufacturing a functionally gradient material having a gradient from a first material to a second material different to the first material by ejecting inks onto a base material from a plurality of inkjet heads, the method comprising:
a supply step of supplying a plurality of inkjet heads respectively with a plurality of mixed inks in which a first functional ink containing the first material and a second functional ink containing the second material are mixed at respectively different mix ratios;
a selection step of selecting one inkjet head in order from the plurality of inkjet heads according to a ration of the first functional ink, the inkjet head being selected in order from an inkjet head to which a mixed ink having a highest ratio of the first functional ink is supplied;
a forming step of causing the selected inkjet head to eject the mixed ink so as to form one layer; and
a laminating step of stacking a plurality of layers onto the base material by repeating the forming step, so as to obtain a laminated body.

14. The method of manufacturing a functionally gradient material as defined in claim 13, wherein, in the forming step, one layer is formed by the mixed ink while relatively moving the base material and the plurality of inkjet heads a plurality of times, the mixed ink being arranged discretely by one relative movement of the base material and the plurality of inkjet heads, and interpolation between discretely arranged positions of the mixed ink being performed by the plurality of relative movements of the base material and the plurality of inkjet heads.

15. The method of manufacturing a functionally gradient material as defined in claim 1, wherein the forming step includes a semi-drying step of semi-drying the formed layer.

16. The method of manufacturing a functionally gradient material as defined in claim 13, wherein the forming step includes a semi-drying step of semi-drying the formed layer.

17. The method of manufacturing a functionally gradient material as defined in claim 1, wherein the laminating step includes, after forming a mixed layer of the first functional ink and the second functional ink, a second subsidiary ink disposition step of disposing a second subsidiary ink causing diffusion in a vicinity of a boundary between the formed layer and a layer formed subsequently.

18. The method of manufacturing a functionally gradient material as defined in claim 13, wherein the laminating step includes, after forming a mixed layer of the first functional ink and the second functional ink, a second subsidiary ink disposition step of disposing a second subsidiary ink causing diffusion in a vicinity of a boundary between the formed layer and a layer formed subsequently.

19. The method of manufacturing a functionally gradient material as defined in claim 1, wherein the plurality of layers include a mixed ink which only contains the first functional ink and does not contain the second functional ink and/or a mixed ink which only contains the second functional ink and does not contain the first functional ink.

20. The method of manufacturing a functionally gradient material as defined in claim 13, wherein the plurality of layers include a mixed ink which only contains the first functional ink and does not contain the second functional ink and/or a mixed ink which only contains the second functional ink and does not contain the first functional ink.

21. The method of manufacturing a functionally gradient material as defined in claim 15, wherein, in the semi-drying step, drying is delayed if drying of the formed layer is fast.

22. The method of manufacturing a functionally gradient material as defined in claim 16, wherein, in the semi-drying step, drying is delayed if drying of the formed layer is fast.

23. The method of manufacturing a functionally gradient material as defined in claim 15, further comprising a measurement step of measuring an extent of drying of the formed layer,
wherein in the semi-drying step, each formed layer is semi-dried according to the measured extent of drying.

24. The method of manufacturing a functionally gradient material as defined in claim 16, further comprising a measurement step of measuring an extent of drying of the formed layer,
wherein in the semi-drying step, each formed layer is semi-dried according to the measured extent of drying.

25. The method of manufacturing a functionally gradient material as defined in claim 1, further comprising a lyophobization step of rendering an outer perimeter portion of each formed layer lyophobic with respect to an ink to be ejected subsequently, after each layer is formed.

26. The method of manufacturing a functionally gradient material as defined in claim 13, further comprising a lyophobization step of rendering an outer perimeter portion of each formed layer lyophobic with respect to an ink to be ejected subsequently, after each layer is formed.

27. The method of manufacturing a functionally gradient material as defined in claim 1, further comprising a frame generating step of providing a frame for surrounding an ink to be ejected subsequently, at an outer perimeter portion of each formed layer, after each layer is formed.

28. The method of manufacturing a functionally gradient material as defined in claim 13, further comprising a frame generating step of providing a frame for surrounding an ink to be ejected subsequently, at an outer perimeter portion of each formed layer, after each layer is formed.

29. The method of manufacturing a functionally gradient material as defined in claim 1, further comprising a lyophilic step of rendering the ink ejected first onto a surface of the base material lyophilic properties, before the forming step.

30. The method of manufacturing a functionally gradient material as defined in claim 13, further comprising a lyophilic step of rendering the ink ejected first onto a surface of the base material lyophilic properties, before the forming step.

31. The method of manufacturing a functionally gradient material as defined in claim 1, wherein each of the steps is carried out in an inert gas atmosphere.

32. The method of manufacturing a functionally gradient material as defined in claim 13, wherein each of the steps is carried out in an inert gas atmosphere.

33. The method of manufacturing a functionally gradient material as defined in claims 1, further comprising a sintering step of sintering the laminated body at a prescribed sintering temperature.

34. The method of manufacturing a functionally gradient material as defined in claims 13, further comprising a sintering step of sintering the laminated body at a prescribed sintering temperature.

35. An apparatus for manufacturing a functionally gradient material having a gradient from a first material to a second material different to the first material by ejecting inks onto a base material from a plurality of inkjet heads, the apparatus comprising:
a first inkjet head which ejects a first functional ink containing the first material;
a second inkjet head which ejects a second functional ink containing the second material;
a control device which controls a volume of the first functional ink ejected from the first inkjet head and a volume of the second functional ink ejected from the second inkjet head;
a forming device which causing the first inkjet head and the second inkjet head to eject the first functional ink and the second functional ink so as to form one layer; and
a laminating device which obtains a laminated body by stacking a plurality of layers by the forming device,
wherein the control device specifies a ratio between the first functional ink and the second functional ink in such a manner that respective layers of the plurality of layers progressively have a smaller ratio of the first functional ink and a larger ratio of the second functional ink, toward an upper layer.

36. An apparatus for manufacturing a functionally gradient material having a gradient from a first material to a second material different to the first material by ejecting inks on a base material from a plurality of inkjet heads, the apparatus comprising:
a supply device which supplies the plurality of inkjet heads respectively with a plurality of mixed inks in which a first functional ink containing the first material and a second functional ink containing the second material are mixed at respectively different mix ratios;
a selection device which selects one inkjet head in order from the plurality of inkjet heads according to a ration of the first functional ink, the inkjet head being selected in order from an inkjet head to which a mixed ink having a highest ratio of the first functional ink is supplied;
a forming device which causes the selected inkjet head to eject the mixed ink so as to form one layer; and
a laminating device which obtains a laminated body by stacking a plurality of layers on the base material by repeating formation of the layer by the forming device.
